(19) United States
(12) Patent Application Publication
(10) Pub. No.: US 2019/0112450 A1
(43) Pub. Date: Apr. 18, 2019

(54) HYDROPONIC MAT

(71) Applicant: MAEZAWA KASEI INDUSTRIES CO., LTD., Tokyo (JP)

(72) Inventors: Takayuki OOBA, Saitama (JP); Hidekazu HANABUSA, Saitama (JP); Youhei OSANAI, Saitama (JP)

(21) Appl. No.: 16/090,188

(22) PCT Filed: Sep. 14, 2016
(86) PCT No.: PCT/JP2016/077170

§ 371 Date: Sep. 28, 2018

(30) Foreign Application Priority Data
Mar. 31, 2016 (JP) 2016-073734

(51) Int. Cl. C08K 3/22; A01G 31/02

(52) U.S. Cl. CPC C08K 3/22; C08L 75/04; A01G 31/02

(57) ABSTRACT

A hydroponic mat (1) according to the present invention includes: a resin foam (3) containing Zn, which is an essential micronutrient necessary for growth of plants, in the form of citric acid-soluble ZnO particles (2) (zinc oxide). The ZnO particles (2) have an average particle size within a range (not less than 0.02 μm and not greater than 0.7 μm) that causes scattering for the wavelength of light that chlorophyll of algae absorbs. The content of the ZnO particles (2) in the resin form (3) is not less than 4.5 mg/piece and not greater than 15.0 mg/piece.

### TECHNICAL FIELD

The present invention relates to a hydroponic mat having a plant growth promoting effect and an anti-algae effect.

### BACKGROUND ART

In recent years, cultivation in plant factories has attracted attention as a system capable of producing plants throughout the year without an influence of climate change. Plant factories generally employ hydroponic culture.

Known methods to promote growth of plants cultivated in plant factories include a method using a light source radiating a wavelength effective for photosynthesis of plants and a method devising the types and quantities of elements blended in a culture nutrient solution (hereinafter, referred to as a “nutrient solution”), that is, essential macronutrients and essential micronutrients. The “essential macronutrients” herein refer to elements required by plants in comparatively large quantities, such as N, P, and K. The “essential micronutrients” herein refer to elements which are not required by plants in large quantities but essential for the growth of plants. The essential micronutrients for plants include for example Fe, Mn, B, Zn, Mo, Cu, and Cl.

Essential micronutrients are required by plants in very small quantities but play important roles. In soil cultivation, since soils often contain essential micronutrients, plants are less likely to develop deficiencies. In hydroponic culture, however, as described above, essential micronutrients need to be supplied to plants by producers blending essential micronutrients in nutrient solutions or any other means.

The essential micronutrients affect plants in very small quantities but easily cause excess symptoms. It is very difficult for producers to manage nutrient solutions by applying each essential micronutrient separately. For this reason, Patent Literature 1 for example proposes a plant growth environment material, a hydroponic mat, and the like which are manufactured by kneading fertilizer components effective on growth of plants and the like into cellulose acetate resin foam and shaping the same. In addition, Patent Literature 2 for example proposes a method that uses a sintered body containing a metal compound of Cu or Zn as a plant cultivation bed.

### CITATION LIST

### Patent Literature

Patent Literature 1: Japanese Patent Application Publication No. 2001-247866

Patent Literature 2: Japanese Patent Application Publication No. 2010-239898

### SUMMARY OF INVENTION

### Technical Problem

However, if fertilizer components and the like are added to a culture medium in order to give a growth promoting effect to plants like Patent Literature 1, unwanted organisms, such as algae requiring the fertilizer components similarly to object plants, are generated. Propagation of algae, as unwanted organisms other than plants, contaminates planting boards and hydroponic mats used in hydroponic culture, thus increasing the viable cell counts of bacteria, reducing the workability, and degrading the appearance. Furthermore, algae absorb the components (nutrients) of the nutrient solution, which are intended to be absorbed by plants, hindering the growth of plants and causing diseases.

To provide antibacterial activity and anti-algae activity, not limited to equipment for hydroponic culture, a method is employed in which a metal compound to elute antibacterial metal ions is supplied as described in Patent Literature 2. To provide an effect of controlling unwanted organisms, such as algae (an anti-algae effect), it is necessary to add many metal compounds (Cu, Zn, Ag, and the like) to an object designed to have such an effect. In this specification, the “anti-algae effect” refers to an effect of inhibiting generation, growth, and propagation of algae or destroying algae.

In Patent Literature 2, the effect of controlling unwanted organisms is obtained by adding Cu or Zn to a porous sintered cultivation bed which is an equipment for hydroponic culture. As described above, Cu and Zn are essential micronutrients of plants but are needed by plants in very small quantities. If Cu or Zn is supplied in excess of plants' needs, plants develop excess symptoms. For example, lettuce, which is cultivated widely in hydroponic culture, develops excess symptoms when the Zn concentration of the nutrient solution is 3 ppm or more.

In Patent Literature 2, in order to obtain the effect of controlling unwanted organisms by using metal ions of Cu and Zn compounds, 225 mg of metal compounds is given to a porous sintered cultivation bed. In the cultivation test with ten small green onions in a beaker, the amount of metal compounds per one plant is 22.5 mg. The test using the small green onions in Patent Literature 2 is reported to have resulted in good growth. The inventors of the present invention cultivated plants using a later-described flexible polyurethane foam instead of the porous sintered cultivation bed and giving 18.6 mg of ZnO to the flexible polyurethane foam. The inventors have observed occurrence of yellowing as the Zn excess symptom.

The amount of metal ions eluted out of the porous sintered cultivation bed is unknown in Patent Literature 2. If there is no Zn excess symptom, the amount of eluted metal ions should be very small. It is therefore necessary to increase the amount of metal compounds added to the porous sintered cultivation bed. Variations in amount of eluted metal ions increase the risk of excess symptoms.

In Patent Literature 2, red leaf lettuce cultivation tests and radish germination tests were performed in a hydroponic culture system using the porous sintered cultivation bed. These tests used water. The porous sintered cultivation bed containing essential micronutrients is placed in water not containing a fertilizer or another substance including elements essential for plants. It therefore follows that the porous sintered cultivation bed promotes growth of plants. Hydroponic culture usually uses a nutrient solution containing a good balance of fertilizers including various types of essential elements. Patent Literature 2 does not describe the growth promoting effect of the nutrient solution. Furthermore, the amount of unwanted organisms such as algae generated while plants are cultivated using a nutrient solution is incomparable to that while plants are cultivated using water, for example. Patent Literature 2 does not describe the control of unwanted organisms in the case of using nutrient solutions.

As for algae as a kind of unwanted organisms, there are methods of controlling propagation of algae other than the antibacterial effect of metal ions and the like. One of such methods is coloring a hydroponic mat to control the photosynthesis of algae. In this method, it is necessary to reduce the lightness of the mat. However, as the lightness of the mat is reduced, reflection of light onto plants decreases. Herein, the “lightness” refers to “lightness” which is one of three attributes of color: “hue”, “lightness”, and “saturation”. This specification uses L* as a value of lightness in a L*a*b color space among various color spaces.

The present invention has been made in the light of the aforementioned circumstances, and an object of the present invention is to provide a hydroponic mat having a plant growth promoting effect and an anti-algae effect.

### Solution to Problem

As the results of hard studies to solve the aforementioned problems, the inventors have found that adding zinc oxide (ZnO) particles with the average particle size controlled within a particular range into a hydroponic mat provides the following operational effects. Specifically, the mat of the present invention efficiently exerts the plant growth promoting effect and the effect of controlling growth and propagation of algae with a very small amount of metal compound added to the culture medium and does not cause a risk of excess symptoms of plants while using a nutrient solution containing fertilizers including a good balance of essential elements and the like.

A hydroponic mat according to the present invention to solve the aforementioned problems, comprising

a resin foam including not less than 4.5 mg/piece and not greater than 15.0 mg/piece of zinc oxide having an average particle size of not less than 0.02 μm and not greater than 0.7 μm.

### Advantageous Effects of Invention

According to the present invention, the hydroponic mat has a plant growth promoting effect and an anti-algae effect.

### BRIEF DESCRIPTION OF DRAWINGS

FIG. 1 is a perspective view illustrating an embodiment of a hydroponic mat according to the present invention.

FIG. 2 is a schematic configuration diagram illustrating the configuration of a seedling test system.

FIG. 3 is a schematic configuration diagram illustrating the configuration of an apparatus for circulation tests.

FIG. 4 is a schematic configuration diagram illustrating the configuration of an apparatus for small circulation tests.

FIG. 5 is a schematic configuration diagram illustrating the configuration of an apparatus for root acid elution tests.

FIG. 6 is a schematic configuration diagram illustrating the configuration of an apparatus for photosynthesis tests.

FIG. 7 is a schematic configuration diagram illustrating the configuration of an apparatus to confirm the anti-algae effect.

FIG. 8 is a schematic configuration diagram illustrating the configuration of photometry based on lightness.

FIG. 9 is a graph illustrating the concentration of eluted Zn ions to the number of cells.

FIG. 10 is a graph illustrating the relationship between CO₂ concentration [ppm] and rate of photosynthesis [μmol·s⁻¹·m⁻²] concerning mats according to the present invention and Comparative Example 1.

### DESCRIPTION OF EMBODIMENTS

Hereinafter, an embodiment of a hydroponic mat according to the present invention will be described in detail with reference to the drawings when needed.

### (Hydroponic Mat)

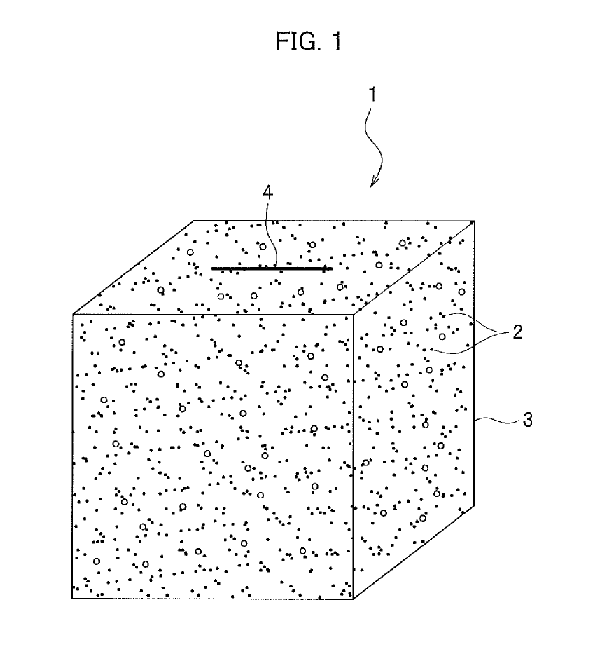

FIG. 1 is a perspective view illustrating an embodiment of the hydroponic mat according to the present invention.

As illustrated in FIG. 1, a hydroponic mat 1 (hereinafter, just referred to as a “mat 1”) according to the embodiment is composed of a resin foam 3 containing ZnO particles 2 having such an average particle size that causes at least one of Mie scattering and Rayleigh scattering for wavelengths of light that chlorophyll of algae absorbs. The resin foam 3 is preferably a later-described flexible polyurethane foam but not limited to this.

The “one piece” in the present invention refers to one mat 1 used to cultivate one plant.

The mat 1 preferably has a rectangular column shape for efficient manufacture and easy handling. As for the size of the mat 1, which is not particularly limited, each side is preferably 10 to 80 mm long and is more preferably 20 to 40 mm long. The mat 1 having such a size facilitates sowing and supports plants suitably. Furthermore, the mat 1 ensures the number of plants cultivated.

As illustrated in FIG. 1, the mat 1 preferably includes a holder 4 that holds seeds of plants to be hydroponically cultivated. The holder 4 is formed by cutting the mat 1 in an I or cross shape in a plan view or depressing the mat 1 in a semispherical or rectangular shape. FIG. 1 illustrates the holder 4 having an I shape in a plan view. The depth of the holder 4 can be set to ½ of the height of the mat 1 from the surface of the mat 1, for example, but not limited to this.

Nutrient solutions generally used in hydroponic culture contains nitrogen, phosphor, and potassium, which are three major elements essential for plants, and calcium and magnesium, which are essential secondary nutrients. Even if the mat 1 contains these essential elements, therefore, there is no great growth effect on plants.

Such a generally used nutrient solution does not contain essential micronutrients in large quantities. This is because even a very small change in amount of each essential micronutrient influences the growth of plants significantly. In the present invention, the essential micronutrients are contained in the mat 1, and the mat 1 has a great growth effect on plants.

The essential micronutrients contained in the mat 1 may be contained in the form of compound. The form of compound containing the essential micronutrients includes oxides, chlorides, hydroxides, nitrides, and sulfides. In order for the mat 1 to has a high growth promoting effect, the mat 1 preferably contains a citric acid-soluble compound of an essential micronutrient. Among such citric acid-soluble compounds of essential micronutrients, ZnO is preferred, which has a high growth promoting effect in particular. If the mat 1 contains a water-soluble compound instead of the aforementioned citric acid-soluble compound, essential micronutrients in the mat 1 dissolve into the nutrient solution quickly. It is therefore difficult to has a growth promoting effect over a long period of time.

### (Citric Acid Solubility)

The “citric acid solubility” in the present invention refers to a property of being soluble to 2.0 w/w % citric acid solution (20° C., pH about 2.1) but insoluble to water. Citric acid-soluble compounds gradually dissolve in various organic acids (also referred to as “root acids”) secreted from plant roots. The “organic acids” herein are a generic term for acids of organic compounds, such as carboxylic acid. The root acids are organic acids secreted from plant roots. Soil culture and the like utilize not only the essential micronutrients but also such citric acid-soluble compounds as delayed release fertilizers. In hydroponic culture, plant roots are immersed in circulating nutrient solution, and the root acids secreted from the roots cannot remain in the rhizosphere of the plant. The citric acid-soluble compounds do not dissolve and are difficult to absorb. The “rhizosphere” herein refers to a region influenced by roots of the plant.

Using the mat 1 according to the embodiment allows plants to efficiently dissolve and absorb ZnO particles 2 over a long period of time, providing a growth promoting effect compared with cultivation using only nutrient solutions. The flexible polyurethane foam used as the mat 1 retains water. The water stream in the mat 1 is extremely slower than the nutrient solution flowing in the cultivation gutter. The roots which spread throughout the mat 1 with growth of plants secrete organic acids. Since the water flows slowly in the mat 1, the organic acids do not run off immediately. The ZnO particles 2 supported by the mat 1 dissolve in the organic acids to be absorbed by the roots. The flexible polyurethane foam herein is a polyurethane foam that flexibly deforms by external load and returns to the original shape when the load is removed. The “flexible polyurethane foam” normally includes continuous micro-cells and thereby cause capillary action to exert water retention ability. The flexible polyurethane foam is therefore suitably used as the mat 1.

The mat 1 thus suitably contains essential micronutrients, which cannot be applied to normal hydroponic culture, as the ZnO particles 2, which are a citric acid-soluble compound. The ZnO particles 2 are white and do not adversely affect the color of the mat 1. If water-insoluble iron oxide or copper oxide is used, the very small amount of components dissolved in water or 2.0 w/w % citric acid aqueous solution is absorbed by the plants and has a growth promoting effect in some cases. However, the compounds, such as iron oxides and copper oxides, are colored themselves, and it is therefore difficult to form the mat 1 in an arbitrary color. The essential micronutrients contained in the mat 1 are therefore preferably the ZnO particles 2.

### (Content of ZnO Particles)

The amount of the ZnO particles 2 contained in the mat 1 is set to not less than 4.5 mg/piece and not greater than 15.0 mg/piece. The amount of the ZnO particle 2 contained in the mat 1 is more preferably set to not less than 4.84 mg/piece and not greater than 14.1 mg/piece. When the amount of the ZnO particles 2 contained in the mat 1 is less than 4.5 mg/piece, the plants cannot get a sufficient growth promoting effect. When the amount of the ZnO particles 2 is greater than 15.0 mg/piece, the plants develop excess symptoms.

For the effect of the ZnO particles 2 in cultivation of plants, the absolute quantity of the ZnO particles 2 contained in the mat 1 is important, not the concentration. If the concentration of the ZnO particles 2 contained in the mat 1 is defined, the aforementioned range of the content of the ZnO particles 2 (not less than 4.5 mg/piece and not greater than 15.0 mg/piece), that provides a plant growth promoting effect, cannot be implemented depending on the apparent density of the resin foam 3 as the substrate of the mat 1.

When the mat 1 has a low apparent density, for example, the aforementioned range of content of the ZnO particles 2 can be implemented by increasing the size of the mat 1. However, increasing the size of the mat 1 has a risk of reducing the workability or increasing the occupancy of the mat 1 in cultivation space. In addition, the root acids secreted from the plant roots could not be distributed sufficiently throughout the mat 1 and fail to sufficiently dissolve the ZnO particles 2 contained in the mat 1.

When the mat 1 has a low apparent density, the aforementioned range of content of the ZnO particles 2 can be also implemented by increasing the concentration of the ZnO particles 2 contained in the mat 1. However, increasing the concentration can degrade the formability at manufacturing of the resin foam 3. In addition, the ZnO particles 2 can aggregate and fail to disperse uniformly.

When the mat 1 has a high apparent density, the aforementioned range of content of the ZnO particles 2 can implemented by reducing the size of the mat 1. In such a case, the mat 1 reduced in size cannot hold the plants sufficiently or produce other disadvantages.

When the mat 1 has a high apparent density, the aforementioned range of content of the ZnO particles 2 can be also implemented by reducing the concentration of the ZnO particles 2 contained in the mat 1. However, the amount of the ZnO particles 2 added to the resin foam 3 becomes small. Therefore the ZnO particles 2 in the resin foam 3 is nonuniformly dispersed or causes variations of its amount to increase. The mat 1 cannot have a growth promoting effect.

### (Plants Growable in Hydroponic Culture)

Plants growable in hydroponic culture with the mat 1 according to the embodiment are C₃ plants, for example. The “C₃ plants” herein refer to plants that incorporate CO₂ in the air directly into the Calvin-Benson cycle (a reductive pentose phosphate cycle) for photosynthesis. Most of plants hydroponically grown in plant factories and the like are C₃ plants. The C₃ plants perform photosynthesis in chloroplasts included in the mesophyll cells. Greenhouse horticulture in plant factories and the like has made studies to promote growth of plants, such as increasing the concentration of carbon dioxide in the environment or changing light sources. The mat 1 of the present invention increases the rate of photosynthesis of plants independently of those external factors.

Herein, consideration is given to the mechanism of action of the plant growth prompting effect of the ZnO particles 2 containing Zn in the mat 1.

A C3 plant includes the Calvin-Benson cycle, which is a basic circuit for photosynthesis, in chloroplasts. CO₂ fixation in the Calvin-Benson cycle occurs as follows:

D-ribulose-1,5-bisphosphate (RuBP)+CO₂+H₂O->two molecules of phosphoglyceric acid Formula 1

To promote photosynthesis of plants, it is necessary to activate ribulose 1,5-bisphosphate carboxylase/oxygenase (RubisCO) that catalyzes the reaction of Formula 1. As a means of activating RubisCO, supply of CO₂, which is the substrate of RubisCO, may be increased. CO₂ incorporated in a chloroplast is converted to bicarbonate ions by carbonic anhydrase (hereinafter, abbreviated as “CA”) and is temporarily stored in the stroma of the chloroplast. The bicarbonate ions stored in the stroma are again converted to carbon dioxide by CA, supporting supply of CO₂ to the Calvin-Benson cycle.

The reaction by CA is as follows:

CO₂+H₂O<->HCO₃⁻+H⁺ Formula 2

Formula 2 expresses a reversible reaction. CA catalyzing this reaction includes a Zn ion at the active center. Since the mat 1 contains the ZnO particles 2 including Zn, it is inferred that an increase in supply of Zn ions to plants increases production of CA, thereby further promoting the reaction of Formula 2.

While CO₂ incorporated in the stroma is temporarily converted into bicarbonate ions by CA, the increased CA promotes the reaction that converts bicarbonate ions, which is the backward reaction of Formula 2. This increases supply of CO₂ as the substrate of RubisCO and promotes the reaction of Formula 1 as the initial reaction of the Calvin-Benson cycle, resulting in promotion of the Calvin-Benson cycle itself. As the reaction of Formula 1 is promoted, the CO₂ concentration in the stroma decreases. The plant then opens the stomata to increase the intake of CO₂ for continuous promotion of photosynthesis.

The plant weight increases exponentially. The amount of CA required to maintain the plant growth promoting effect therefore increases. If supply of Zn ions is stopped during the growth, the relative amount of CA in the plant decreases. Such a decrease in CA drastically lowers the rate of photosynthesis. This is because the plant with the photosynthesis promoted by the ZnO particles 2 including Zn, which are contained in the mat 1, requires a higher amount of CO₂. The growth rate therefore rapidly slows down in some cases. In such a case, it is preferable to use the mat 1 throughout the entire period from sowing to harvesting. In the other cases, the mat 1 may be used only in a predetermined period of time, such as from sowing to seedling.

When the supply of Zn ions is started in the middle of growth, it is difficult to provide a high promoting effect because the CO₂ requirement depends on the previous growth to some extent. In order to provide a plant growth promoting effect of the ZnO particles 2 including Zn, it is preferred that Zn ions are supplied from the ZnO particles 2 throughout the entire period from the beginning of the growth. From this perspective, the ZnO particles 2 contained in the mat 1 are preferably citric acid-soluble as described above.

Most land plant are C₃ plants, and the mat 1 according to the embodiment is applicable to any of such land plant. The “land plant” herein refer to a group of green plants growing on land, including spermatophyte, bryophyte, and pteridophyte. Examples of the C₃ plants hydroponically grown in the present invention include Japanese mustard spinach, leaf radish, and cabbage (Brassicaceae), leaf lettuce (Asteraceae), spinach (Chenopodiaceae), small green onion (Liliaceae), Mitsuba (Apiaceae), and perilla (Lamiaceae).

The mat 1 according to the embodiment is applicable to C₄ plants including a pathway to concentrate CO₂ in the air as a first step before the Calvin-Benson cycle or CAM plants that store CO₂ during the night and cause reactions in the Calvin-Benson cycle during the day. The “C₄ plants” herein refer to plants having a pathway to concentrate CO₂ in addition to the Calvin-Benson cycle. Examples thereof are corns (Poaceae). The “CAM plants” refer to plants that store CO₂ during the night and reduce CO₂ during the day. Examples thereof are cacti.

### (Average Particle Size)

As described above, the ZnO particles 2 added to the mat 1 promote photosynthesis to provide a growth promoting effect. Furthermore, the ZnO particles 2 reduce generation and propagation of algae (the anti-algae effect).

Algae generated in hydroponic culture contaminate a planting board 10 or the mat 1 used as a planting medium, causing problems including an increase bacteria, poor workability, and degraded appearance. Development of algae requires “light”, “water”, and “nutrients”, which are often the same as demands of cultivated plants. The components of the nutrient solution that are supposed to be absorbed by the cultivated plants are deprived by algae, causing growth inhibition of plants. Application of essential nutrients to promote the growth of plants sometimes promotes generation and propagation of algae.

In the mat 1 of the present invention, the average particle size of the ZnO particles 2 including Zn as an essential micronutrient is set in such a range that at least one of Mie scattering and Rayleigh scattering takes place for the wavelengths of light that chlorophyll absorbs. The mat 1 thus controls generation and propagation of algae.

Herein, the “chlorophyll” in the present invention includes chlorophyll a, chlorophyll b, and the like.

The “Mie scattering” refers to a light scattering phenomenon that takes place when light hits a particle comparable in size to the wavelength thereof. In the Mie scattering, the way and intense of scattering vary depending on the relationship between the light wavelength and the particle size. When wavelength λ is comparable to particle size D, Mie scattering takes place uniformly independently of the wavelength of light. Mie scattering is maximized when the particle size D is equal to λ/2 to λ.

When the ZnO particles 2 contained in the mat 1 have such an average particle size that causes Mie scattering for the wavelength of light that chlorophyll absorbs, light at such a wavelength and is used in photosynthesis by chlorophyll undergoes Mie-scattering. The ZnO particles 2 having such an average particle size reduce transmission of light from the top surface of the mat 1 into the same. This makes it difficult for algae to undergo photosynthesis within the mat 1, inhibiting generation and propagation of algae (the anti-algae effect). Since the generation and propagation of algae are inhibited, the components of the nutrient solution are hardly deprived by algae. The plants are less subject to growth inhibition due to algae. Part of the scattered light irradiate the plants to contribute to photosynthesis in the plants. Furthermore, since the ZnO particles 2 added to the mat 1 are white, the mat 1 is not colored, thus efficiently utilizing light reflected or scattered from the mat 1 to the plants.

Green algae and plants more advanced include chlorophyll a and chlorophyll b as the photosynthetic pigments. Generally, the ratio of chlorophyll a to chlorophyll b is about 3/1. Chlorophyll a absorbs light with wavelengths of around 440 nm and around 680 nm while chlorophyll b absorbs light with wavelengths of around 480 nm and around 630 nm.

For example, the light source used to cultivate plants is a three-band fluorescent lamp (daylight). The three-band fluorescent lamp (daylight) emits light with wavelengths of around 440 nm, around 490 nm, around 550 nm, around 580 nm, and around 610 nm. The “three-band fluorescent lamp” herein refers to a lamp that provides more natural color by using rear-earth phosphors for color bands called three wavelength bands of three primary colors (blue, green, and red).

The wavelength of light absorbed by chlorophyll are not always equal to the wavelength of light emitted from the light source. However, the mat 1 contains the ZnO particles 2 having a particle size that causes Mie scattering for the wavelengths of light absorbed by chlorophyll or the wavelengths of light emitted from the light source. This inhibits generation and propagation of algae in the mat 1.

When the light source is a three-band fluorescent lamp (daylight), the mat 1 is configured to contain the ZnO particles 2 having an average particle size that causes Mie scattering of light at a wavelength of around 440 nm, light at a wavelength of 480 to 490 nm, and light at a wavelength of 610 to 630 nm. The wavelength of around 440 nm corresponds to the wavelength of light that is absorbed by chlorophyll a, which is abundant, and the wavelength of light emitted from the three-band fluorescent lamp (daylight). The wavelength of 480 to 490 nm and the wavelength of 610 to 630 nm correspond to the wavelength of light that is absorbed by chlorophyll b, which is less abundant, and the wavelength of light emitted from the three-band fluorescent lamp (daylight). Herein, chlorophyll a, which is abundant, also absorbs light with a wavelength of around 680 nm. However, it is unnecessary to consider scattering of light with this wavelength because the three-band fluorescent lump (daylight) does not emit light with this wavelength.

Mie scattering is maximized when the particle size D is λ/2 to λ as described above. When the light source is a three-band fluorescent lamp (daylight), in order to inhibit generation and propagation of algae in the mat 1, the ZnO particles 2 contained in the mat 1 preferably have an average particle size of 0.2 to 0.5 μm. Such a particle size maximizes Mie scattering of light at a wavelength of around 440 nm, which corresponds to the wavelength of light absorbed by chlorophyll a, that is abundant, and the wavelength of light emitted from the three-band fluorescent lamp (daylight). Furthermore, the average particle size of the ZnO particles 2 may be determined by taking into account of Mie scattering of light with a wavelength of 610 to 630 nm, which corresponds to the wavelength of light absorbed by chlorophyll b, that is less abundant, and the wavelength of light emitted from the three-band fluorescent lamp (daylight). The average particle size that causes Mie scattering of light with a wavelength of 610 to 630 nm is 0.3 to 0.6 μm.

The above description is given of the average particle size of the ZnO particles 2 contained in the mat 1 to provide an anti-algae effect in the case where the light source is the three-band fluorescent lamp (daylight). The present invention is not limited to this. Three-band fluorescent lamps vary in color type, including daylight, natural white, and light bulb types. Three-band fluorescent lamps of different color types emit light with the same wavelengths, but at different intensities in some cases. When the light source is a three-band fluorescent lamp, the average particle size of the ZnO particles 2 is properly selected depending on the color type, that is, the intensity of light at each wavelength. In plant factories and other facilities using sunlight, the light source is sunlight including a wide range of wavelengths. As for plant factories using total artificial light, various studies have been made to use new light sources other than fluorescent lamps, such as LEDs, as the light source. The wavelength of light emitted from the light source vary from light source to light source. The average particle size of the ZnO particles 2 contained in the mat 1 in order to provide an anti-algae effect is properly selected depending on the wavelength of light absorbed by chlorophyll and the wavelength of light emitted from the light source. Preferably, the mat 1 contains the ZnO particles 2 having a particle size of 0.2 to 0.7 μm, that causes Mie scattering for the wavelength of light absorbed by chlorophyll a. This inhibits generation and propagation of algae in the mat 1.

In the embodiment, the mat 1 also has an anti-algae effect when the average particle size of the ZnO particles 2 is set to a size small enough to cause Rayleigh scattering for wavelengths of light absorbed by chlorophyll a and chlorophyll b. The “Rayleigh scattering” herein refers to a light scattering phenomenon that mainly takes place when light hits a particle with a particle size smaller than the wavelength of the light (particle size D<=λ/10, for example). The intensity of Rayleigh scattering is proportional to the sixth power of the particle size and inversely proportional to the fourth power of the wavelength. The scattering intensity is lowered if the particle size is too small. The intensity of Rayleigh scattering of light in the long-wavelength range not shorter than 600 nm, that is absorbed by chlorophyll, is also lowered. To provide an anti-algae effect due to Rayleigh scattering, the average particle size of the ZnO particles 2 contained in the mat 1 is preferably 0.02 to 0.07 μm. The ZnO particles 2 having an average particle size of 0.07 to 0.2 μm cause both Mie scattering and Rayleigh scattering. Each intensity of Mie scattering and Rayleigh scattering is not very high. However, the total intensity of Mie scattering and Rayleigh scattering produces an anti-algae effect.

Thus, the average particle size of the ZnO particles 2 contained in the mat 1 is preferably set to 0.02 to 0.7 μm so to produce an anti-algae effect by causing Mie scattering or Rayleigh scattering for wavelengths of light that is absorbed by chlorophyll included in algae and wavelengths of light emitted from the light source. Such an average particle size allows the mat 1 to have an efficient anti-algae effect.

The ZnO particles 2 having the aforementioned average particle size can be manufactured by atomization or pulverization using a ball mill or the like, for example. The “atomization” herein refers to a process that applies a jetted fluid to a flow of molten metal to form powder. The “ball mill pulverization” refers to a process to ground a material into powder by using a ball mill as a type of grinder. The ZnO particles 2 can be commercially-available ones.

The average particle size of the ZnO particles 2 is preferably determined using median size (D50) as the index, for example. The average particle size of the ZnO particles 2 can be easily measured with an apparatus according to JIS Z 8825: 2013 (Particle size analysis-Laser diffraction methods) or the like. In the present invention, using the average particle size measured with such an apparatus as the reference is preferred because of easy adjustment of the ZnO particles 2 and the like. Consequently, when the measured average particle size of the ZnO particles 2 falls in the aforementioned range of particle size, most of the ZnO particles 2 cause Mie scattering or Rayleigh scattering.

### (Resin Foam)

The ZnO particles 2 are supported and fixed within resin struts or on the surface of the resin struts in the process of forming the resin foam 3 to have a plant growth promoting effect and an anti-algae effect.

The resin foam 3 has an open cell structure. In a resin foam including a closed-cell structure, the cells are provided separately from each other. The resin foam therefore cannot be impregnated with the nutrient solution. With the open-cell structure, the resin foam 3 is able to include the nutrient solution inside due to the capillary action and retain the nutrient solution. In addition, the resin foam 3 includes countless struts due to the open cell structure, and the nutrient solution hardly enters the resin foam 3 from the outside. The resin foam 3 is thus less likely to lose the root acids secreted from the roots spread inside. The resin foam 3 thereby properly retains Zn ions generated by the root acids and allows the generated Zn ions to be absorbed by the roots. It is therefore possible to easily and properly supply the plants with the essential micronutrients, the supply and addition of which were difficult to control in conventional hydroponic culture. The resin foam 3 is preferably flexible polyurethane foam. Flexible polyurethane foam is already universally used in hydroponic culture, and producers are familiar with the same. By using such flexible polyurethane foam, the mat 1 can has an excellent plant growth promoting effect and an anti-algae effect without changing the cultivation conditions and facilities.

The apparent density of the resin foam 3 is preferably set to not less than 10 kg/m³ and not greater than 40 kg/m³. This allows the ZnO particles 2 to disperse uniformly in the resin foam 3, providing a stable plant growth promoting effect. The apparent density herein refers to a mass per unit volume of a specimen including both open and closed cells. The apparent density is calculated according to JIS K 7222:2005 (Cellular plastics and rubbers Determination of apparent (bulk) density).

The number of cells of the resin foam 3 is preferably 10 to 100 pores/25 mm and more preferably 30 to 70 pores/25 mm, for example. The “cells” herein refer to cavities in the structure of a porous material like the resin foam 3. The resin form 3 with the above-described number cells improves in water retention ability and suitably supplies water to plants at sowing and just after germination in particular. The resin foam 3 with the aforementioned number of cells is less likely to prevent the plant roots from stretching, thus exerting a positive effect on root spread. The number of cells is calculated according to JIS K6400-1: 2004 (Flexible cellular polymeric materials—Determination of physical properties Appendix 1—Determination of number of cells).

The hardness of the resin foam 3 is preferably set to 20 to 300 N/314 cm² and more preferably 30 to 70 N/314 cm². The resin form 3 with the above-described hardness suitably supports plants. The resin form 3 including the above-described hardness is also less likely to prevent the plant roots from stretching, thus exerting a positive effect on root spread. Furthermore, the resin form 3 improves the workability of producers at settled planting and transplanting. The hardness is calculated by method D of JIS K 6400-2: 2012 (Flexible cellular polymeric materials—Physical properties—Part 2: Determination of hardness (indentation technique) and stress-strain characteristics in compression).

The resin foam 3 is preferably flexible polyurethane foam as described above but is not limited to this. The resin foam 3 can be any synthetic resin foam with a number of cells and a hardness equal to those of the aforementioned flexible urethane foam. Examples of such synthetic resin foams are polystyrene foam, polyethylene foam, and polypropylene foam.

### (Mat Manufacturing Method)

The mat 1 according to the embodiment can be manufactured with equipment and under conditions typically used to manufacture hydroponic mats. An example of the method of manufacturing the mat 1 is described concretely for the resin foam 3 being flexible polyurethane foam.

First, a composition of polyol, isocyanate, a blowing agent, a foam stabilizer, a catalyst, and the like and the ZnO particles 2 are blended and foamed by equipment such as a low-pressure or high-pressure foaming machine, thus fabricating a flexible polyurethane foam in a desired shape, such as a slab foam or a molded foam. The “polyol” herein is a compound including plural alcoholic hydroxyl groups and is a raw material of polyurethane. The “isocyanate” is a compound including a partial structure of —N═C═O and is a raw material of polyurethane with polyol. The “blowing agent” is an agent which is added to a base resin to generate gas and form a cellular structure. The “foam stabilizer” is to form uniform and fine foam. The “slab foam” is a foam obtained by pouring the mixture of raw materials onto a continuous conveyer, continuously foaming the mixture into a product having a rectangular or substantially U-shaped cross section to the longitudinal direction, and then cutting the product into predetermined pieces. The “molded foam” is a foam obtained by injecting the mixture of raw materials into a plastic mold or the like for foaming and taking out the foamed product from the mold. Such flexible polyurethane foam can be also manufactured by hand foaming. The “hand foaming” herein refers to a process to meter each raw material in a beaker or the like and stirring the same for foaming.

The method of blending the ZnO particles 2 and the other raw materials is not particularly limited. For example, the raw materials other than isocyanate are mixed and dispersed in polyol in advance as a polyol premix, which is then reacted with isocyanate. Alternatively, the raw materials may be individually metered, mixed, and reacted. Thereafter, cell membranes may be removed by crushing or explosion treatment. The “crushing” herein refers to a process performed to break the cell membranes formed at foaming to stabilize the shape of the molded product and prevent shrinkage of the foam. The “explosion treatment” refers to removing cell membranes with energy of explosion. The resin foam 3 may be manufactured by using a composition of raw materials that cannot form cell membranes at foaming.

The fabricated flexible polyurethane foam is subjected to secondary processing using a vertical cutter, a horizontal cutter, or the like into a sheet with a predetermined thickness. The sheet of flexible polyurethane foam is cut into a predetermined size using a blade-type cutting machine or the like, thus producing the mats 1. The mats 1 having a desired shape can be fabricated by punching with a blade-type cutting machine using a die such as a Thomson blade, boring with a boring machine, and the like.

At processing with the blade-type cutting machine, the holder 4 can be provided at the center of the mat 1 in a plan view. This facilitates sowing and allows the roots of germinated plants to easily penetrate the mat 1. The sheet of flexible polyurethane foam is subjected to boring before or after cutting with a blade-type cutting machine for processing to prevent seeds from displacing at sowing.

### (Usage of Mat)

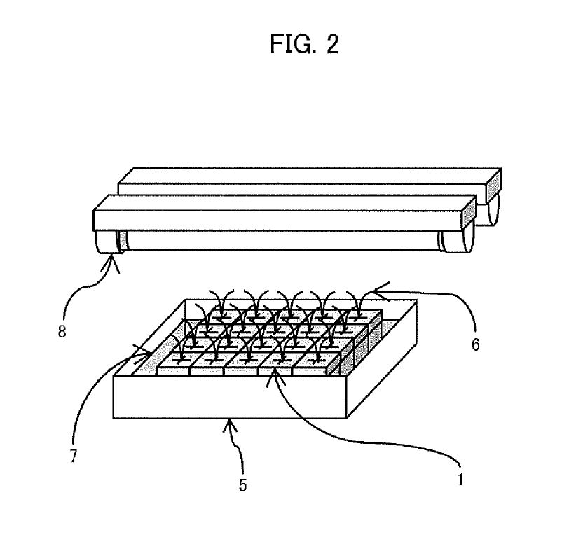

The Mat 1 is used in a hydroponic tray, such as a seedling tray or growing tray, or a nutrient solution tank, or the like (see FIGS. 2 to 4. FIGS. 2 to 4 are described later). Before or after the mat 1 is placed in the hydroponic tray, seeds of plants are sowed in the holder 4. After the sowing, the nutrient solution is circulated or regularly replaced for hydroponic cultivation. The mat 1 may be fixed in a hole provided for a planting board 10 if necessary. The planting board 10 herein is a board made of a material such as expanded polystyrene or expanded polypropylene in deep flow technique, for example. This board can be floated in water or the nutrient solution. The mat 1 is fixed in a hole provided for the board, which is floated in the nutrient solution for supporting and fixing plants. However, the present invention is not limited to the aforementioned example.

As described above, the mat 1 according to the embodiment has a plant growth promoting effect and an anti-algae effect. Using the mat 1 according to the embodiment promotes the growth of plants in general hydroponic systems (deep flow technique, nutrient film technique, and the like). It is therefore possible to shorten the period of cultivation until the plant grows to a prescribed weight or increase the harvest weight in a prescribed period of cultivation.

Furthermore, since the mat 1 as a culture medium itself has a plant growth promoting effect, it is unnecessary to add Zn as an essential micronutrient, the addition of which is difficult to adjust, to the nutrient solution or to add Zn to another tank. The mat 1 according to the embodiment reduces the producers' labor. The mat 1 according to the embodiment can be collected at the harvest of plants, distributed, and discarded. At the start of next cultivation, therefore, new mats 1 are replenished. It is therefore possible to supply Zn constantly and stably without paying attention on the time of replacement of the material given the plant growth promoting effect. There is no possibility of Zn deficiency. Still furthermore, since the ZnO particles 2 contained in the mat 1 are citric acid-soluble, the mat 1 continues to have a plant growth promoting effect and an anti-algae effect over a long period of time. Since the ZnO particles 2 contained in the mat 1 are citric acid-soluble, the concentration of Zn ions in the nutrient solution cannot increase in short time. Plants are therefore less likely to develop excess symptoms. The “deep flow technique” in the specification refers to a method of cultivation with the plant roots and culture medium immersed in the nutrient solution. The “nutrient film technique” refers to a method of cultivation with the planting medium existing in air and the plant roots exposed to the nutrient solution and air.

### EXAMPLES

Next, a description is given of the mat according to the present invention more concretely based on Examples.

In Example 1, the mats 1 were fabricated as follows. The raw materials of flexible polyurethane foam constituting the mat 1 were CEF-385 (isocyanate, made by TOSOH CORPORATION) and NEF-612 (polyol premix, made by TOSOH CORPORATION). ZnO (made by SAKAI CHEMICAL INDUSTRY CO., LTD.) with an average particle size of 0.29 μm, as the ZnO particles 2, was added to NEF-612 and mixed for uniform dispersion. The added ZnO was 2.0 w/w % of the total composition weight. CEF-385 was inputted to the mixture, followed by sufficient stirring and mixing, thus producing flexible polyurethane foam. The produced flexible polyurethane foam was cut into pieces (24 mm long×24 mm wide×28 mm thick) as the mat 1. The physical properties of the obtained mat 1 were as follows: the apparent density was 30 kg/m³; and the number of cells was 50 pores/25 mm. The ZnO particles 2 contained in the mat 1 was 9.49 mg/piece.

Examples 2 to 9 and Comparative Examples 1 to 26 were obtained under the same conditions as those of Example 1 except that the ZnO particles 2 in Example 1 were changed to particles of another compound or the amount of the additive was changed. The additives and the contents thereof in Examples 2 to 9 and Comparative Examples 1 to 26 are shown in Table 1. In Table 1, symbols “-” indicate that the item was not measured or could not be measured because the mat 1 did not contain particles or the like.

In Examples 5 and 6 and Comparative Examples 21 and 22, in order to adjust the number of cells, methylene chloride was properly added to NEF-612 as the blowing agent just before NEF-612 and CEF-385 were mixed. The mats 1 with the number of cells adjusted to other than 50 pores/25 mm were produced.

TABLE 1

| | | Average | | | |
|---|---|---|---|---|---|
| | | Particle | Content | Content | Number |
| | Additive | Size of | Percentage | Weight of | of cells |
| | (Parti- | Additive | of Additive | Additive | (pores/ |
| Mat 1 | cles 2) | (μm) | (W/W %) | (mg/piece) | 25 mm) |
| Example 1 | ZnO | 0.29 | 2.0 | 9.49 | 50 |
| Example 2 | ZnO | 0.29 | 1.0 | 4.84 | 50 |
| Example 3 | ZnO | 0.29 | 1.5 | 7.15 | 50 |
| Example 4 | ZnO | 0.29 | 2.9 | 14.1 | 50 |
| Example 5 | ZnO | 0.29 | 2.0 | 9.49 | 30 |
| Example 6 | ZnO | 0.29 | 2.0 | 9.49 | 13 |
| Example 7 | ZnO | 0.02 | 1.0 | 4.84 | 50 |
| Example 8 | ZnO | 0.45 | 1.0 | 4.84 | 50 |
| Example 9 | ZnO | 0.60 | 1.0 | 4.84 | 50 |
| Comparative | No | — | — | — | 50 |
| Example 1 | additive | | | | |
| Comparative | Mg(OH)₂ | — | 1.0 | 4.84 | 50 |
| Example 2 | | | | | |
| Comparative | Mg(OH)₂ | — | 2.0 | 9.49 | 50 |
| Example 3 | | | | | |
| Comparative | Mg(OH)₂ | — | 2.9 | 14.1 | 50 |
| Example 4 | | | | | |
| Comparative | MgO | — | 1.0 | 4.84 | 50 |
| Example 5 | | | | | |
| Comparative | MgO | — | 2.0 | 9.49 | 50 |
| Example 6 | | | | | |
| Comparative | MgO | — | 2.9 | 14.1 | 50 |
| Example 7 | | | | | |
| Comparative | CaCO₃ | — | 1.0 | 4.84 | 50 |
| Example 8 | | | | | |
| Comparative | CaCO₃ | — | 2.0 | 9.49 | 50 |
| Example 9 | | | | | |
| Comparative | CaCO₃ | — | 2.9 | 14.1 | 50 |
| Example 10 | | | | | |
| Comparative | Zinc | — | 1.0 | 4.84 | 50 |
| Example 11 | Stearate | | | | |
| Comparative | Zinc | — | 1.0 | 4.84 | 50 |
| Example 12 | Laurate | | | | |
| Comparative | ZnCl₂ | — | 0.10 | 0.48 | 50 |
| Example 13 | | | | | |
| Comparative | ZnCl₂ | — | 0.25 | 1.21 | 50 |
| Example 14 | | | | | |
| Comparative | ZnCl₂ | — | 0.50 | 2.42 | 50 |
| Example 15 | | | | | |
| Comparative | ZnSO₄ | — | 0.10 | 0.48 | 50 |
| Example 16 | | | | | |
| Comparative | ZnSO₄ | — | 0.25 | 1.21 | 50 |
| Example 17 | | | | | |
| Comparative | ZnSO₄ | — | 0.50 | 2.42 | 50 |
| Example 18 | | | | | |
| Comparative | ZnO | 0.29 | 3.8 | 18.6 | 50 |
| Example 19 | | | | | |
| Comparative | ZnO | 0.29 | 4.8 | 23.0 | 50 |
| Example 20 | | | | | |
| Comparative | No | — | — | — | 13 |
| Example 21 | additive | | | | |
| Comparative | ZnO | 0.29 | 2.0 | 9.49 | 7.5 |
| Example 22 | | | | | |
| Comparative | ZnO | 0.01 | 1.0 | 4.84 | 50 |
| Example 23 | | | | | |
| Comparative | ZnO | 1.0 | 1.0 | 4.84 | 50 |
| Example 24 | | | | | |
| Comparative | ZnO | 2.0 | 1.0 | 4.84 | 50 |
| Example 25 | | | | | |
| Comparative | ZnO | 10 | 1.0 | 4.84 | 50 |
| Example 26 | | | | | |

Comparative Examples 27 to 33 shown below were obtained under the same conditions except that the ZnO particles 2 in Example 1 were changed to toner FTR-5570 (carbon black content was 20 to 30%) (Dainichiseika Color & Chemicals Mfg. CO., Ltd.) and the amount thereof was changed. The additive and the content thereof in Comparative Examples 27 to 33 are shown in Table 2. In Table 2, symbols “-” indicate that the item was not measured.

TABLE 2

| | | Average | | | |
|---|---|---|---|---|---|
| | | Particle | Content | Content | Number |
| | | Size of | Percentage | Weight of | of cells |
| | Additive | Additive | of Additive | Additive | (pores/ |
| Mat 1 | (Toner) | (μm) | (W/W %) | (mg/piece) | 25 mm) |
| Comparative | FTR-5570 | — | 0.13 | 0.63 | 50 |
| Example 27 | | | | | |
| Comparative | FTR-5570 | — | 0.50 | 2.42 | 50 |
| Example 28 | | | | | |
| Comparative | FTR-5570 | — | 1.00 | 4.84 | 50 |
| Example 29 | | | | | |
| Comparative | FTR-5570 | — | 1.25 | 6.15 | 50 |
| Example 30 | | | | | |
| Comparative | FTR-5570 | — | 2.91 | 14.5 | 50 |
| Example 31 | | | | | |
| Comparative | FTR-5570 | — | 0.20 | 0.97 | 50 |
| Example 32 | | | | | |
| Comparative | FTR-5570 | — | 0.125 | 0.61 | 50 |
| Example 33 | | | | | |

Using Examples 1 to 9 and Comparative Examples 1 to 33, the followings were performed.

[A] Confirm the dissolution of particles made of the citric acid-soluble compound by root acids
[B] Confirm plant growth promoting effect of mats containing particles
[C] Confirm plants which has the plant growth promoting effect
[D] Confirm the significance of adding particles made of citric acid-soluble compound to mats
[E] Consider the principle of plant growth promoting effect due to particles made of Zn compound
[F] Confirm and consider anti-algae effect

In FIGS. 2 to 8, reference numeral 1 indicates mats; 5, a seedling tray; 6, a plant; 7, nutrient solution; 8, a light source; 9, a planting tray; 10, a planting board; 11, an submersible motor; 12, a nutrient solution tank; 13, a tube to supply the nutrient solution to the planting tray; 14, an overflow tube; 15, an air pump; 16, an air tube; 17, a flowmeter; 18, a supply air-side CO₂ monitor; 19, a chamber; 20, water; 21, an exhaust air-side CO₂ monitor; 22, a testing vessel; and 23, an illuminometer. In the following tests, the “nutrient solution 7” was OAT house Formula A (dilution factor=1.0, made by OAT Agrio Co., Ltd.). The nutrient solution 7 was properly added to control the nutrient solution 7 so that pH=6 and EC value=2.5. The “EC value” in the present invention refers to an electric conductivity of the nutrient solution.

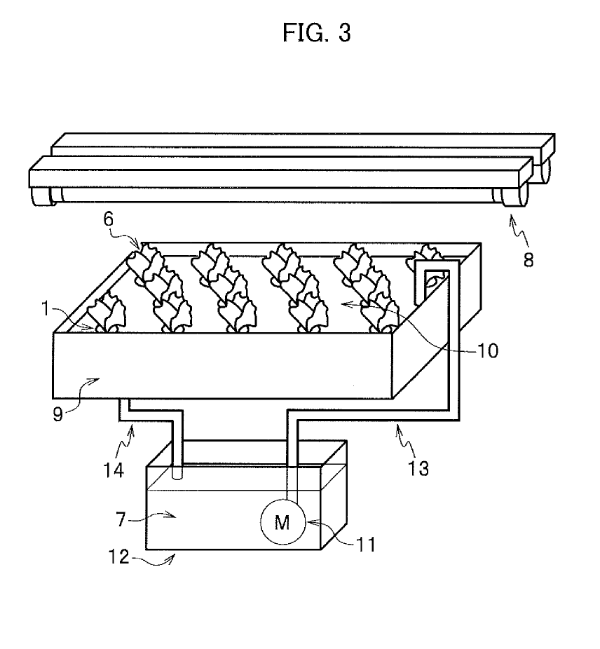

The cultivation process in the present invention includes the steps of: 1. Germination, 2. Seedling, and 3. Settled planting. Each step was performed as follows. The ambient temperature at each step was about 20° C. (see FIGS. 2 and 3).

### 1. Germination (See FIG. 2)

The “germination” in the present invention refers to a step from sowing of seeds of plants in the mat 1 to germination of the seeds. The step was performed according to the following procedure.

(1) The mats 1 were laid closely in the seedling tray 5 without space therebetween and were impregnated with tap water with a ratio of 20 mL/piece.
(2) One seed was sowed in each mat 1 of the aforementioned (1).
(3) The germination step was performed in the dark for three days. To prevent evaporation of water, the seedling tray 5 was covered with a lid (not illustrated).

### 2. Seedling (See FIG. 2)

The “seedling” in the present invention refers to a step of growing sprouts of the germinated plants to a size large enough to be transplanted (to an extent that the roots of the plants penetrate the bottom of the mat 1). The seedling step was performed according to the following procedure.

(4) After the germination step, the tap water in the seedling tray 5 was replaced with the nutrient solution 7, and the plants were irradiated with the light source 8.
(5) The light source 8 was a three-band fluorescent lamp (daylight, 10,000 lx). The plants were continuously irradiated for 14 hours and were left in the dark for subsequent 10 hours in a day. The period of seedling was set to seven days. The cultivation environments were set as follows: the temperature was 20° C., the relative humidity was 60%, and the CO₂ concentration was 700 ppm.

### 3. Settled Planting (See FIG. 3)

The “settled planting” in the present invention refers to a step of fixing each of the mats 1 with the seedlings of the plants 6 grown to a certain size in the seedling step to one of the holes of the planting board 10 in the circulation apparatus illustrated in FIG. 3; and growing the seedlings until harvesting. The holes were provided at regular intervals in the planting board 10. The settled planting step was performed in the following procedure. In the circulation apparatus illustrated in FIG. 3, the nutrient solution 7 was circulated.

(6) After the seedling step, each of the mats 1 with the seedlings of the plants 6 grown was fixed to one of the holes provided at regular intervals in the planting board 10 for transplanting. The intervals between the holes were 80 mm. The amount of the nutrient solution 7 in the planting tray 9 per mat 1 was controlled to 1 L.
(7) The light source 8 was a three-band fluorescent lamp (daylight, 18,000 lx). The plants were continuously irradiated for 14 hours and were left in the dark for subsequent 10 hours in a day. The cultivation environments were set as follows: the temperature was 20° C., the relative humidity was 60%, and the CO₂ concentration was 700 ppm.
(8) In the settled planting step, as the plants 6 grew, the plants 6 got crowded and inhibited the growth each other. The plants were transplanted again to the planting board 10 with holes provided at larger intervals. The intervals between the holes were 150 mm. The transplanting was performed 14 days after the first transplanting.

In the present invention, the sum of the days required at each step of 1. Germination, 2. Seedling, and 3. Settled planting was referred to as the “number of cultivation days”, which was recorded for each test described later.

Tests for [A] to [F] described above were performed using any one of the apparatuses illustrated in FIGS. 2 to 8. Hereinafter, a description is given of the methods of tests, including algae tests, seedling tests, circulation tests, small circulation tests, and photosynthesis tests, which were employed as the tests for [A] to [F], the corresponding drawings, and the details of the tests.

### (Seedling Test)

In a seedling test, the aforementioned steps of the cultivation process: 1. Germination and 2. Seedling were performed. Irradiation was performed with the hours of irradiation by the light source 8 changed to 24 hours/day.

(Circulation test)

In a circulation test, the steps of the cultivation process: 1. Germination, 2. Seedling, and 3. Settled planting were performed. The flow rate of the nutrient solution 7 by the submersible motor 11 was set to 2.0 L/min. In the case of continuous cultivation, the flow rate of the nutrient solution 7 by the submersible motor 11 was set to 6.0 L/min.

### (Small Circulation Test)

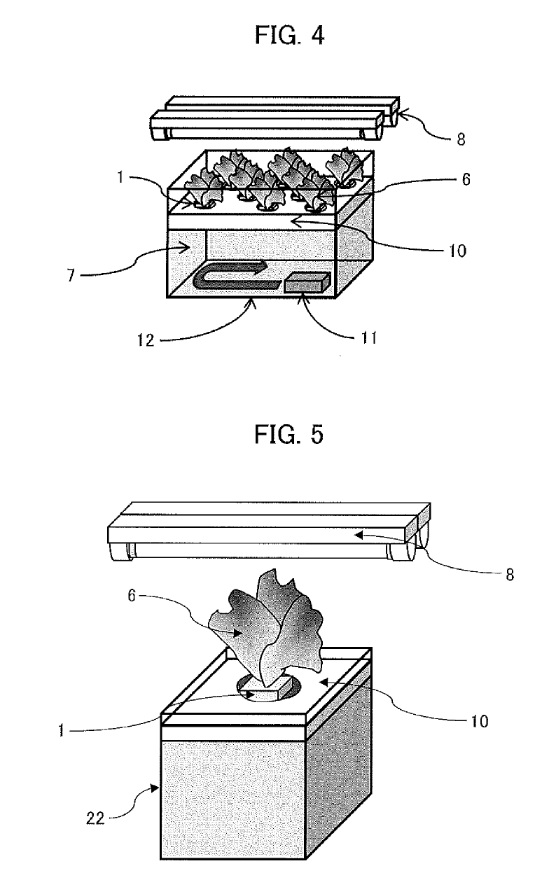

In a small circulation test, the steps of: 1. Germination to 3. Settled planting were performed under the same conditions as those of the circulation test using the apparatus illustrated in FIG. 4. The flow rate of the nutrient solution 7 by the submersible motor 11 was set to 2.0 L/min.

### [A] Confirm the Dissolution of Particles Made of Citric Acid-Soluble Compound by Root Acids

### [A-1] Secretion of Root Acid

### (Root Acid Secretion Test)

In soil culture, organic acids (root acids) secreted from plant roots gradually dissolve the citric acid-soluble compound in the rhizosphere, and the eluted ions are absorbed by the plant roots. In hydroponic culture, the nutrient solution is circulated, and the root acids cannot remain in the rhizosphere. The citric acid-soluble compound is hardly dissolved and absorbed. It was analyzed whether, in hydroponic culture, root acids existed in the mat and nutrient solution. When the root acids existed, the properties of the components thereof were analyzed.

The root acid secretion test was performed as follows using the apparatus illustrated in FIG. 5 with reference to the following document.
Reference Document: OKURA Minoru (Chuo University graduate school), SUZUKI Yoshinari (Chuo University graduate school, and FURUTA Naoki (Chuo University graduate school), “Identification of organic acids discharged from roots of tomato (lycopersicon esculentum) grown in hydroculture”, JSAC meeting proceedings, vol. 58, p. 55

### (Test Method)

(1) Frillice (registered trademark, by SNOW BLAND SEED CO., Ltd.) as the plant 6 was cultivated using the mat 1 (not containing Zn) of Comparative Example 1 in the same method as the aforementioned circulation test.
(2) The nutrient solution 7 adhering to the roots of the cultivated plant 6 and the mat 1 was washed off with ion-exchange water.
(3) The plant 6 was then cultivated for more five days in the apparatus of FIG. 5 with the testing vessel 22 filled with ion exchange water. The light source 8 was a three-band fluorescent lamp (daylight, 18,000 lx). The plant 6 was continuously irradiated for 14 hours and were left in the dark for 10 hours in a day.
(4) Five days later, the ion exchange water within the mat 1 and the ion exchange water within the tank were sampled as root acid-dissolved solutions.
(5) The sampled root acid-dissolved solutions were concentrated by a factor of 20 and were qualitatively analyzed using liquid chromatography (LC).
(6) The results are shown in Table 3.

TABLE 3

| | Detected Root Acid Components |
|---|---|
| Ion Exchange Water Within Mat 1 of | Malic Acid, Succinic Acid, |
| Comparative Example 1 | Lactic Acid |
| Ion Exchange Water in Tank | Not Detected |

As shown in Table 3, root acids were detected from the ion exchange water within the mat 1. These results reveal that root acids are secreted also in hydroponic culture. However, no organic acids were detected from the ion exchange water in the tank. In actual cultivation, therefore, a large amount of the root acids secreted from the roots remain in the mat 1 while the amount of root acids dissolved in the nutrient solution 7 was significantly small. Consequently, the root acids are contained in very small quantities in the nutrient solution 7 outside the mat 1, and the citric acid-soluble compound is less likely to dissolve. Furthermore, since the root acids remain in the mat 1, the mat 1 containing the citric acid-soluble compound including an essential micronutrient allows for more efficient elution of the essential micronutrient than when the essential micronutrient is contained in the nutrient solution 7.

### [A-2] Citric Acid-Solubility of ZnO

### (Test of Dissolution of ZnO in Citric Acid Aqueous Solution)

The examination of [A-1] confirmed that the root acids were secreted from the plant roots and remain in the mat 1 in large quantities also in hydroponic culture. Then, the dissolution test was performed for ZnO including Zn as an essential micronutrient of plants, which is contained in the mat 1 according to the embodiment. The solvent used in the dissolution test was 2 w/w % citric acid aqueous solution (20° C.). The test was performed as follows.

### (Test Method)

(1) Distilled water was added to citric acid (purity>=99.5%, by Taiyo Pharmaceutical Co., Ltd.), thus preparing a 2.0 w/w % citric acid aqueous solution.
(2) The 2.0 w/w % citric acid aqueous solution (20° C.) prepared above was stirred with a magnetic stirrer while ZnO was added thereto.
(3) After it was confirmed that ZnO was completely dissolved in the 2.0 w/w % citric acid aqueous solution (20° C.), ZnO further continued to be added.
(4) The aforementioned operations (2) and (3) were repeated. The total weight of ZnO added until ZnO could not completely dissolved was obtained as the solubility of ZnO to the 2.0 w/w % citric acid aqueous solution.

The solubility of ZnO to 100 g of the 2.0 w/w % citric acid aqueous solution (20° C.) was 1580 mg, which shows that ZnO was citric acid-soluble. This suggests that since the mat 1 contains the ZnO particles 2, the ZnO particles 2 dissolve in the root acids existing in the mat 1 and plants absorb Zn efficiently.

### [B] Confirm Plant Growth Promoting Effect of Mats Containing Particles.

### [B-1] Plant Growth Promoting Effect of Various Compounds

### (Seedling Test)

Next, the plant growth promoting effect was confirmed using the mat 1 of Examples and Comparative Examples containing compounds including essential elements, (including the mat 1 of Example 1 containing the ZnO particles 2), and the mat 1 of Comparative Example 1 not containing an essential element. The added compounds and the contents thereof in the mats 1 are shown in Tables 1 and 2.

The aforementioned seedling test was performed using the thus-obtained mats 1. The cultivated plants were Frillice. As for the number of cultivation days in the cases of adding Mg and Ca compounds, the period of 1. Germination was set to three days, and the period of 2. Seedling was set to 21 days. In the case of adding Zn compounds, the period of 1. Germination was set to three days, and the period of 2. Seedling was set to 27 days. After hydroponic cultivation of each seedling test was finished, the ratio of the weight of aerial part of the picked plants hydroponically cultivated in each mat 1 to that of the plants hydroponically cultivated in the mats 1 of Comparative Example 1 (not including an essential element) was calculated as a growth promoting factor. The results are shown in Table 4.

TABLE 4

| | | | | | Growth | |
|---|---|---|---|---|---|---|
| | | | | | Promoting | |
| | | | | Content | Factor | |
| | | | Content | Percentage | (Aerial | |
| | Solubility | | Weight of | of | Part | |
| Additive | of | | Additive | Additive | Weight | |
| to Mat 1 | Additive | Mat 1 | (mg/piece) | (w/w %) | Ratio) | Note |
| Magnesium | Citric | Comparative | 4.84 | 1.0 | 0.87 | |
| Hydroxide | acid-soluble | Example 2 | | | | |
| Mg(OH)₂ | | Comparative | 9.49 | 2.0 | 0.71 | |
| | | Example 3 | | | | |
| | | Comparative | 14.1 | 2.9 | 1.00 | |
| | | Example 4 | | | | |
| Magnesium | Water-insoluble | Comparative | 4.84 | 1.0 | 0.93 | |
| Oxide | | Example 5 | | | | |
| MgO | | Comparative | 9.49 | 2.0 | 0.95 | |
| | | Example 6 | | | | |
| | | Comparative | 14.1 | 2.9 | 0.86 | |
| | | Example 7 | | | | |
| Calcium | Water-insoluble | Comparative | 4.84 | 1.0 | 0.91 | |
| Carbonate | | Example 8 | | | | |
| CaCO₃ | | Comparative | 9.49 | 2.0 | 1.04 | |
| | | Example 9 | | | | |
| | | Comparative | 14.1 | 2.9 | 0.68 | |
| | | Example 10 | | | | |
| Zinc | Citric | Example 2 | 4.84 | 1.0 | 1.44 | |
| Oxide | acid-soluble | Example 1 | 9.49 | 2.0 | 1.45 | |
| ZnO | | | | | | |
| Zinc | Water-insoluble | Comparative | 4.84 | 1.0 | 0.85 | |
| Stearate | | Example 11 | | | | |
| Zinc | Water-insoluble | Comparative | 4.84 | 1.0 | 0.81 | |
| Laurate | | Example 12 | | | | |
| Zinc | Water-soluble | Comparative | 0.48 | 0.10 | 1.05 | |
| Chloride | | Example 13 | | | | |
| ZnCl₂ | | Comparative | 1.21 | 0.25 | 1.26 | Yellowed |
| | | Example 14 | | | | |
| | | Comparative | 2.42 | 0.50 | 1.43 | Yellowed |
| | | Example 15 | | | | |
| Zinc | Water-soluble | Comparative | 0.48 | 0.10 | 1.39 | |
| Sulfate | | Example 16 | | | | |
| ZnSO₄ | | Comparative | 1.21 | 0.25 | 1.12 | Yellowed |
| | | Example 17 | | | | |
| | | Comparative | 2.42 | 0.50 | 1.11 | Yellowed |
| | | Example 18 | | | | |

As illustrated in Table 4, the results of the tests for various compounds show that ZnO had a plant growth promoting effect.

In the tests for water-soluble ZnCl₂ and ZnSO₄, the plant weight increased, but yellowing as the excess symptom occurred.

Zinc stearate and zinc laurate as organic metal compounds did not have a plant growth promoting effect.

As for the inorganic compounds including magnesium and calcium as essential macronutrients, there was no plant growth promoting effect exerted with such a degree of content of the compound in the mat 1 because the compound was contained in the nutrient solution in very large quantities.

The above examination results revealed that the ZnO particles 2 including Zn as an essential micronutrient had a plant growth promoting effect because the ZnO particles 2 were citric acid-soluble.

[B-2] Comparison of Citric Acid-Soluble Zn Compound with Water-Soluble Zn Compound

### (Circulation Test)

The aforementioned [B-1] examined the plant growth promoting effect of the Zn compound. The tests performed in [B-1] only examined the germination and seedling steps. The comparison was made on the plant growth promoting effects of the citric acid-soluble Zn compound and water-soluble Zn compound by performing cultivation using the deep flow technique widely used in plant factories until harvesting.

The test used the mats 1 of Example 1 (containing ZnO; 9.49 mg/piece), Comparative Example 13 (containing ZnCl₂; 0.48 mg/piece), Comparative Example 16 (ZnSO₄; 0.48 mg/piece), and Comparative Example 1 (not containing Zn).

The cultivation test was performed through the aforementioned circulation test using the mats 1 of Examples and Comparative Examples. The cultivated plants were Frillice. The number of cultivation days was set as follows: the period of 1. Germination was three days; the period of 2. Seedling was 14 days; and the period of 3. Settled planting was 21 days. The ratio of the weight of aerial part of the picked plant hydroponically cultivated in each mat 1 to that of the plant hydroponically cultivated in the mat 1 of Comparative Example 1 (not containing an essential element) was calculated as a growth promoting factor. The results are shown in Table 5.

TABLE 5

| | Comparative | | | |
|---|---|---|---|---|
| | Example 1 | | | |
| | (Not | | Comparative | Comparative |
| | Containing | Example 1 | Example 13 | Example 16 |
| | Zn) Not | (Containing | (Containing | (Containing |
| Mat 1 | Processed | ZnO) | Zncl₂) | Znso₄) |
| Content Weight | 0.00 | 9.49 | 0.48 | 0.48 |
| of Zn | | | | |
| Compound | | | | |
| [mg/piece] | | | | |
| Content | 0.00 | 2.00 | 0.10 | 0.10 |
| Percentage of | | | | |
| Zn Compound | | | | |
| [W/W %] | | | | |
| Growth | 1.00 | 1.34 | 1.19 | 1.08 |
| Promoting | | | | |
| Factor | | | | |
| (Aerial Part | | | | |
| Weight Ratio) | | | | |

The results of Table 5 show that ZnO, which was soluble to citric acid, was most excellent in plant growth promoting effect.

Based on the results shown in Tables 4 and 5, as for the mats 1 containing a water-soluble compound including an essential micronutrient, such as ZnCl₂ and ZnSO₄, all of the water-soluble compound is eluted in the nutrient solution during the cultivation period even if the water-soluble compound is coated with the resin component of the flexible polyurethane foam as the substrate of the mat 1 and is slowly released. The plant growth promoting effect is therefore not maintained sufficiently. If the content of the water-soluble component in the mat is increased in order to maintain the plant growth promoting effect sufficiently, the plants will develop excess symptoms. It is therefore difficult to provide a plant growth promoting effect by adding the water-soluble compound to the mat 1. On the other hand, the citric acid-soluble Zn compound dissolves in the nutrient solution 7 gradually. The mat 1 containing the Zn compound in an amount small enough for plants not to develop excess symptoms is able to maintain the plant growth promoting effect sufficiently during cultivation.

### [B-3] Difference in Plant Growth Promoting Effect Due to Addition of Zn Between Each Growth Stage

### (Circulation Test)

The difference in plant growth promoting effect due to addition of Zn between growth stages was examined.

This examination was made using the mats 1 of Example 1 (containing ZnO; 9.49 mg/piece) and Comparative Example 1 (not containing Zn).

The aforementioned circulation test was performed using those mats 1 of Examples and Comparative Examples. The cultivated plants were Frillice. The number of cultivation days was set as follows: the period of 1. Germination was three days; the period of 2. Seedling was 10 days; and the period of 3. Settled planting was 13 days.

After the seedling step, at which the germination and seedling steps were finished, and after the settled planting step, the fabricated mats 1 were properly changed as indicated by Circulation Tests No. 1 to 4 in Table 6. The difference in plant growth promoting effect due to addition of Zn between the growth stages was then examined. The ratio of the total weight of Frillice hydroponically cultivated in the circulation tests No. 1 to 4 to the total weight of Frillice of the circulation test No. 1 was calculated as a growth promoting factor. The results are shown in Table 6.

TABLE 6

| Circulation | Mat 1 | | Growth Promoting Factor |
|---|---|---|---|
| Test No. | Seedling | Settled Planting | (Total Weight Ratio) |
| 1 | Comparative | Comparative | 1.00 |
| | Example 1 | Example 1 | |
| 2 | Comparative | Example 1 | 0.95 |
| | Example 1 | | |
| 3 | Example 1 | Comparative | 1.11 |
| | | Example 1 | |
| 4 | Example 1 | Example 1 | 1.57 |

As shown in Table 6, it was confirmed that the plant growth promoting effect was higher when the Zn ions were supplied to plants from the ZnO particles 2 in the seedling step than when Zn ions are supplied in the settled planting step.

When the addition of Zn ions from the ZnO particles 2 is stopped in the middle of cultivation, the plant growth promoting effect is reduced. Zn ions are preferably supplied from the ZnO particles 2 throughout from the seedling step to settled planting step. When the concentration of Zn ions supplied from the Zn particles 2 is reduced, the concentrations of Zn ions in the mat 1 and in the plants 6 lose the balance. The plants 6 therefore absorb Zn ions by consuming energy against the gradient in concentration. The above-described examination results already confirmed that reduction in supply of Zn ions reduced the plant growth promoting effect which had been obtained in early times. From the necessity of continuously supplying Zn ions until harvesting and maintaining the balanced concentrations in the mat 1 and in the plants, the plant growth promoting effect of citric acid-soluble zinc compounds is higher than that of water-soluble zinc compounds.

### [B-4] Examine the Plant Growth Promoting Effect in Relation to Content of ZnO Particles 2 in Mat 1

### (Circulation Test)

The plant growth promoting effect was examined for various values of the content of the ZnO particle 2 in the mat 1.

The examination was performed using the mats 1 of Examples containing the ZnO particles 2, Comparative Examples containing other than the ZnO particles 2, and Comparative Example 1 not including an essential element to confirm the plant growth promoting effect. The aforementioned circulation test was performed using those mats 1 of Examples and Comparative Examples. The cultivated plants were Frillice. The number of cultivation days was set as follows: the period of 1. Germination was three days; the period of 2. Seedling was seven days; and the period of 3. Settled planting was 30 days. The ratio of the total weight of the picked plants hydroponically cultivated in each mat 1 to the total weight of the plants hydroponically cultivated in the mats 1 of Comparative Example 1 (not containing an essential element) was calculated as a growth promoting factor. The results are shown in Table 7. The growth promoting factor of Comparative Example 1 is set to 1.00, which is not shown in Table 7.

TABLE 7

| | | | | | | Comparative | Comparative |
|---|---|---|---|---|---|---|---|
| | | Example 2 | Example 3 | Example 1 | Example 4 | Example 19 | Example 20 |
| ZnO | W/W % | 1.0 | 1.5 | 2.0 | 2.9 | 3.8 | 4.8 |
| Content | mg/piece | 4.84 | 7.15 | 9.49 | 14.1 | 18.6 | 23.0 |
| of Mat 1 | | | | | | | |

| | | | | | | |
|---|---|---|---|---|---|---|
| Growth Promoting | 1.26 | 1.36 | 1.24 | 1.28 | 1.29 | 1.06 |
| Factor | | | | | | |
| (Total Weight | | | | | | |
| Ratio) | | | | | | |
| Note | | | | | Yellowed | Yellowed |

As shown in Table 7, it was confirmed that as for the mats 1 where the content weight of the ZnO particles 2 in the mat 1 was 4.84 to 18.6 mg/piece, the weight of plants increased compared with Comparative Example 1 (not containing an essential element). The plants cultivated in the mat 1 with a ZnO content of 18.6 mg/piece developed yellowing as the Zn excess symptom in the seedling stage. The obtained results suggest that the plant growth promoting effect can be provided when the content of ZnO particles 2 per mat 1 is not less than 4.5 mg/piece and not greater than 15.0 mg/piece. Preferably, the content of ZnO particles 2 per mat 1 is not less than 4.84 mg/piece and not greater than 14.1 mg/piece.

### [B-5] Zn Concentration and Plant Growth Promoting Effect in Continuous Cultivation

### (Circulation Test)

The Zn concentration of the nutrient solution 7 and the plant growth promoting effect in continuous cultivation were examined.

This examination was performed by the circulation test using the mats 1 of Example 1 (containing ZnO; 9.49 mg/piece) and Comparative Example 1 (not containing Zn).

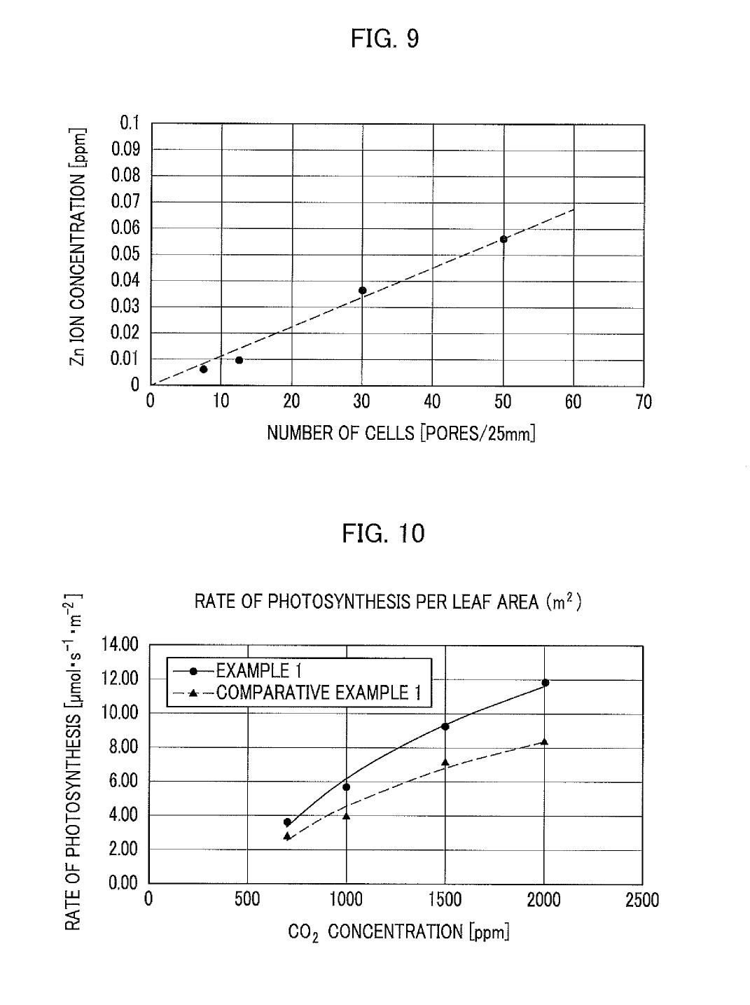

The cultivated plants were Frillice. In this examination, the cultivation conditions were changed as follows. The number of cultivation days was set as follows: the period of 1. Germination was three days; the period of 2. Seedling was 14 days; and the period of 3. Settled planting was 28 days. The illuminance was 15,000 lx; the room temperature, 24° C.; and the CO₂ concentration was 1,500 ppm. In the settled planting step, the illuminance was 20,000 lx; the room temperature, 24° C.; and the CO₂ concentration was 1,500 ppm. The nutrient solution 7 was OAT house Formula SA (dilution factor: 1.0, made by OAT Agrio Co., Ltd.). The nutrient solution 7 was set to pH=7 and EC value=2.5. The number of cultivation days was set to five sets of 45 days. The Zn concentration [ppm] of the nutrient solution 7 in the planting tray 9 was measured before the start of the test, at the end of the first set, and at the end of the fifth set. The Zn concentration [ppm] of the nutrient solution 7 in the mat 1 was measured at the end of the fifth set. The ratio of the total weight of the picked plants hydroponically cultivated in the mats 1 of Example 1 to the total weight of the plants hydroponically cultivated in the mats 1 of Comparative Example 1 (not containing an essential element) was calculated as a growth promoting factor. The results are shown in Tables 8 and FIG. 9.

The number of cultivation days of five sets of 45 days means that cultivation from sowing to harvesting for 45 days is repeated five times continuously. Each set of cultivation was performed by using new mats 1 and sowing new seeds of plants. During the continuous cultivation, the nutrient solution 7 circulating in the circulation apparatus was not replaced with new one. The nutrient solution 7 was adjusted properly only for controlling pH, EC value, and flow rate.

TABLE 8

| | | Example 1 | |
|---|---|---|---|
| | | ZnO Content Weight of | |
| | | Nutrient Solution 7 | |
| | | (9.49 mg/piece) | |
| | | | Growth |
| | | Zn | Promoting Factor |
| Nutrient Solution | Nutrient Solution | Concentration | (Total Weight |
| 7 Sampling Phase | 7 Sampling Place | (ppm) | Ratio) |
| At Start of Test | Planting Tray 9 | 0.0723 | — |
| At Harvesting Of | Planting Tray 9 | 0.0756 | 1.2 |
| 1st Set | | | |
| At Harvesting Of | Planting Tray 9 | 0.0257 | 1.2 |
| 5th Set | Mat 1 | 0.2470 | |

As shown in Table 8, it was confirmed that Zn in the nutrient solution 7 was consumed during the continuous cultivation. On the other hand, the total weight of the picked plants cultivated in the mats 1 of Example 1 (containing ZnO; 9.49 mg/piece) was 20 percent greater than that of the plants cultivated in the mats 1 of Comparative Example 1 (not containing ZnO) while the Zn concentration of the nutrient solution 7 was reduced after five sets of continuous cultivation. It was therefore confirmed that the plant growth promoting effect of Example 1 was higher than that of Comparative Example 1.

Furthermore, it was confirmed that imbalance in Zn concentration inhibits production of the plant growth promoting effect as described in [B-3]. In general plant factories, imbalance of the nutrient solution 7 due to continuous cultivation reduces the crop of the plants 6 in some cases. In addition, the essential elements in the nutrient solution 7 are generally managed based on the EC value. The EC value management rather plays a role of controlling essential macronutrients, especially three primary nutrients of nitrogen, phosphor, and potassium. When the EC value is reduced, adjustment of the concentration of the nutrient solution 7 is performed. In this process, it is difficult to control the concentration of essential micronutrients, which are added in very small quantities compared with the amount of water. In many cases, therefore, the essential elements are not individually added to the nutrient solution 7, and comprehensive fertilizers including essential macronutrients and essential micronutrients are directly added or added in the form of condensed liquid. In continuous cultivation, the concentration of essential micronutrients of the nutrient solution 7 is reduced in some cases as shown in Table 8. Even is the EC value is maintained at a normal level, reduction in essential micronutrients causes insufficient growth of the plants 6. In this examination, the Zn concentration of the nutrient solution 7 was reduced at the fifth set, and the crop was supposed to be reduced. However, when the mat 1 includes the ZnO particles 2, the Zn concentration of the mat 1 is maintained at a high level as shown in Table 8. The total weight of plants was not reduced even at harvesting of the fifth set. By using the mat 1 of the present invention, the plant growth promoting effect is reproductively given to the plants 6 independently of the concentration of essential micronutrients of the nutrient solution 7.

Based on the results that the Zn concentration of the mat 1 was maintained at a high level and a lot of root acids remained in the mat 1 as apparent from [A-1], it is found that the root acids secreted from the roots are retained in the mat 1 and Zn ions are produced from the ZnO particles 2 contained in the mat 1 by the root acids.

[C] Confirm Plants which has the Plant Growth Promoting Effect

In the aforementioned cultivation tests, Frillice widely cultivated in plant factories was examined. The results of cultivation tests for plants cultivated in plant factories, other than Frillice, are shown in Table 9.

In this examination, the plant growth promoting effect was confirmed using the mats 1 of Example 1 (containing ZnO; 9.49 mg/piece) and Comparative Example 1 (not containing Zn). The rate of growth to harvesting varies from plant to plant, and the number of cultivation days was set as described in Table 9.

The aforementioned small circulation test was performed using the mats 1 of Example 1 and Comparative Example 1. The ratio of the weight of aerial part of the picked plant hydroponically cultivated in the mat 1 of Example 1 to the weight of aerial part of the plant hydroponically cultivated in the mat 1 of Comparative Example 1 (not containing an essential element) was calculated as a growth promoting factor. The results are shown in Table 9.

TABLE 9

| | Harvest Weight or Height | | | Growth | |
|---|---|---|---|---|---|
| | | | Comparative | Promoting | |
| | | | Example 1 | Factor | |
| | | | (Not | (Aerial | Cultivation |
| | | Example 1 | containing | Part Wait | Days |
| | Unit | (Containing ZnO) | ZnO) | Ratio) | (Days) |
| Japanese Mustard | (g) | 55.90 | 35.43 | 1.58 | 27 |
| Spinach | | | | | |
| (Brassicaceae) | | | | | |
| Leaf Radish | (g) | 63.55 | 28.58 | 2.22 | 26 |
| (Brassicaceae) | | | | | |
| Spinach | (g) | 52.15 | 38.23 | 1.36 | 31 |
| (Chenopodiaceae) | | | | | |
| Small Green Onion | (mm) | 214.00 | 162.00 | 1.32 | 32 |
| (Liliaceae) | | | | | |

As illustrated in Table 9, the weight and height of each plant hydroponically cultivated using the mat 1 of Example 1 (containing ZnO; 9.49 mg/piece) is greater than those of plants hydroponically cultivated using the mat 1 of Comparative Example 1 (not containing Zn). This means that plants other than Frillice can be also harvested earlier or the harvest weight of the plants is greater than before. Leaf radish, which is grown in shorter time than Frillice, can be effectively used to make a quick determination in the circulation tests and the like.

### [D] Confirm the Significance of Adding Particles Made of Citric Acid-Soluble Compound to Mats

When the mat 1 contains a citric acid-soluble Zn compound, “bringing Zn in contact with roots” and “a certain degree of capacity to retain dissolved Zn ions” are estimated to provide a higher plant growth promoting effect.

Hereinafter, the results of examination on the reasons that the mat 1 contains a citric acid-soluble Zn compound are shown.

### [D-1] Aqueous Solution Retention Ability of Mat 1 at Cultivation

(Retention test)

The aforementioned examination in [A-1] and [B-5] confirmed that the mat 1 retained root acids and Zn ions. The following shows a test to examine how much the nutrient solution 7 was retained in the mat 1 in actual cultivation. The test was performed by the method described below. This examination used the mat 1 of Comparative Example 1 (not including Zn).

### (Test Method)

(1) The mat 1 was impregnated with red colored water and was put into the planting board 10 without sowing of plants. The planting board 10 was placed in a test vessel filled with the nutrient solution 7 colored blue.
(2) The blue nutrient solution 7 was circulated by the submersible motor 11 (the flow rate of the submersible motor 11 is 1.8 L/min). The mat 1 was observed until the red water in the mat 1 was replaced with the blue water.

As the results, it took 12 to nearly 24 hours for the liquid contained in the mat 1 of Comparative Example 1 to be completely replaced with blue one. In the detection test for root acids performed in [A-1], root acids were detected in the mat 1. In the circulation test in [B-5], it was confirmed that the Zn concentration in the mat 1 was maintained at a higher level than that of the nutrient solution 7. According to the results of [A-1] and [B-5] and the results of this examination, the root acids and Zn ions are gradually secreted or dissolved before the root acids and Zn ions dissolved in the mat 1 are completely replaced with the nutrient solution 7, and the Zn ions are retained in the mat 1, as obtained in [B-5].

### [D-2] Effect Depending on the Number of Cells

The following test was performed to confirm the plant growth promoting effect and the amount of water retained in the mat 1 in relation to the number of cells of the mat 1 and the amount of dissolved Zn ions in relation to the number of cells.

### (Plant Growth Promoting Effect)

### (Seedling Test)

First, the plant growth promoting effect was confirmed in relation to the number of cells of mat 1.

The examination was performed by the seedling test using the mat 1 of Examples 1 and 6 and Comparative Examples 1, 21, and 22. The cultivated plants were leaf radish. The number of cultivation days was set as follows: the period of 1. Germination was set to three days; and the period of 2. Seedling was set to 11 days. The difference in growth promoting factor depending on addition of Zn and the number of cells was examined. The ratio of the weight of aerial part of the picked plants hydroponically cultivated in the mats 1 to the weight of aerial part of the plants hydroponically cultivated in each mat 1 of Comparative Example 1 was calculated as the growth promoting factor. The number of cells and results of the test are shown in Table 10.

TABLE 10

| | | | | Growth Promoting | |
|---|---|---|---|---|---|
| | Number | | | Factor (Aerial | |
| | of | Content | Content | Part Weight Ratio) | |
| | cells | Weight of | Percentage | Ratio to | |
| | (pores/ | ZnO | of ZnO | Comparative | Ratio to |
| Mat 1 | 25 mm) | (mg/piece) | (w/w %) | Example 1 | Example 1 |
| Comparative | 50 | 0.00 | 0 | 1.00 | 0.93 |
| Example 1 | | | | | |
| Comparative | 13 | 0.00 | 0 | 0.99 | 0.92 |
| Example 21 | | | | | |
| Example 1 | 50 | 9.49 | 2.0 | 1.08 | 1.00 |
| Example 6 | 13 | 9.49 | 2.0 | 1.15 | 1.07 |
| Comparative | 7.5 | 9.49 | 2.0 | 0.89 | 0.83 |
| Example 22 | | | | | |

As shown in Table 10, it was confirmed that the mats 1 containing 9.49 mg of the ZnO particles 2 per piece and having a number of cells of 13 to 50 pores/25 mm (Examples 1 and 6) produced a higher growth promoting factor than that of the other examples. Compared with the mat 1 (Comparative Example 1) not containing the ZnO particles 2 and having a number of cells of 50 pores/25 mm, the mat 1 (Example 1) having the same number of cells of 50 pores/25 mm and containing 9.49 mg of the ZnO particles 2 per piece had a plant growth promoting effect. However, with the mat 1 (Comparative Example 22) having a number of cells of 7.5 pores/25 mm and containing 9.49 mg of the ZnO particles 2 per piece, there was a delay in growth.

The reasons therefor are considered as follows. The mat 1 with a fewer number of cells has a lower ability of retaining root acids in the mat 1 because of the later-described reduction in water retention capacity thereof. In addition, by the coarse cells of the mat 1, that is, thick struts of the mat 1, ZnO distributed and fixed in the struts of the mat is less likely to come into contact with the root acids. This reduces the amount of Zn ions dissolved.

### (Water Retention Capacity)

Next, the amount of water that the mat 1 retains was confirmed in relation to the number of cells of the mat 1.

### (Water Capacity Test)

The test for the water retention capacity of the mat 1 was performed as follows.

### (Test Method)

(1) The weight of the mat 1 (24 mm long×24 mm wide×28 mm high) was measured before the test as a weight before immersion.
(2) The mat 1 was immersed in 100 mL water put in a 200 mL beaker and was kneaded 10 times so as to remove air included in the mat 1 and be impregnated with water.
(3) The mat 1 was taken out so as not to leak water, and the weight thereof was measured as a weight after immersion.
(4) From the measured weights before and after immersion, the amount of water that the mat 1 retains was calculated as a water retention capacity.

The examination was performed through the water retention capacity test using the mats 1 according to Examples 1, 5, and 6 and Comparative Example 22. The number of cells of each mat 1 and the test results thereof are shown in Table 11.

TABLE 11

| | | | | Comparative |
|---|---|---|---|---|
| | Example 1 | Example 5 | Example 6 | Example 22 |
| Number of cells | 50 | 30 | 13 | 7.5 |
| (pores/25 mm) | | | | |
| Water | 13.9 | 12.5 | 8.8 | 7.0 |
| Retention | | | | |
| Capacity (g) | | | | |

As shown in Table 11, it was confirmed that higher the number of cells, the larger the water retention capacity of the mat 1. As the number of cells increases, space between struts of open cells is narrowed, thus increasing the amount of water that the mat 1 retains due to the capillary action. The mat 1 fixed to the planting board 10 floating in the nutrient solution 7 is able to retain a lot of nutrient solution 7 taken up by the capillary action of part of the mat 1 and roots which are in contact with the nutrient solution 7. When the mat 1 retains a larger amount of the nutrient solution 7, the mat 1 also retains larger amounts of secreted root acids and eluted Zn ions.

### (Amount of Eluted Zn Ions)

Next, the concentration of eluted Zn ions was confirmed in relation to the number of cells of the mat 1.

### [Zn Ion Elution Test]

The test for the amount of Zn ions eluted from the mat 1 was performed as follows.

### [Test Method]

(1) The mat 1 (24 mm long×24 mm wide×28 mm high) was immersed in a 20 mL ion exchange water and was kneaded 10 times.
(2) The obtained Zn ion-dissolved liquid was sampled, and the Zn ion concentration was measured by colorimetry. In this examination, the liquid was colored using PACK TEST zinc (low concentration, by Kyoritsu Chemical-Check Lab. Corp.), and the absorbance of the colored specimen was measured with a UV-Visible/NIR spectrophotometer (V-750iRM, by JASCO Corporation) for a quantitative analysis. The “colorimetry” herein refers to a method of coloring a sample using a reagent or the like and measuring the concentration or the like based on the level of color production.

The examination was performed through the Zn ion elution test using the mats 1 according to Examples 1, 5, and 6 and Comparative Example 22. The number of cells of the mat 1 and test results are shown in Table 12 and FIG. 9.

TABLE 12

| | | | | Amount of eluted |
|---|---|---|---|---|
| | ZnO | ZnO | | Zn ions |
| | Content | Content | Number of | Zn Ion |
| | Weight | Percentage | cells | Concentration |
| Mat 1 | (mg/piece) | (w/w %) | (pores/25 mm) | (ppm) |
| Example 1 | 9.49 | 2.0 | 50 | 0.056 |
| Example 5 | 9.49 | 2.0 | 30 | 0.037 |
| Example 6 | 9.49 | 2.0 | 13 | 0.0096 |
| Comparative | 9.49 | 2.0 | 7.5 | 0.0063 |
| Example 22 | | | | |

As shown in Table 12 and FIG. 9, as for the Zn ion concentrations of the examples other than the example with a number of cells of 50 pores/25 mm, it was confirmed that the concentration of eluted Zn ions increased with the number of cells. This is considered to be because with a decrease in number of cells, the resin struts of the flexible polyurethane foam (the substrate of the mat 1) thicken. The proportion of ZnO buried in the resin thereby increases, reducing the amount of eluted Zn ions.

[D-3] Difference in Plant Growth Promoting Effect of Zn Between the Cases where Zn is Contained in the Mat 1 and Zn is Directly Added to the Nutrient Solution

### (Small Circulation Test)

Next, the difference in plant growth promoting effect of Zn was examined between the cases where ZnO is contained in the mat 1 and the Zn concentration of the nutrient solution 7 is increased.

The examination was performed through the small circulation test using the mats 1 according to Example 1 and Comparative Example 1 as shown in small circulation tests No. 1 to 4 in Table 13. The cultivated plants were Frillice. The number of cultivation days was set as follows: the period of 1. Germination was three days; the period of 2. Seedling was seven days; and the period of 3. Settled planting was 27 days. The nutrient solution 7 was OAT house Formula A (the dilution factor was 1.0; Zn concentration was 0.09 ppm; by OAT Agrio Co., Ltd.). For comparison, hydroponic cultivation was performed using the nutrient solution 7 prepared by adding ZnSO₄ to the nutrient solution 7 to increase the Zn concentration to 1 ppm. The ratio of the weight of aerial part of Frillice hydroponically cultivated in each of the small circulation tests No. 1 to 4 to the weight of aerial part of Frillice hydroponically cultivated in the small circulation tests No. 1 and 2 was calculated as the growth promoting factors. The results are shown in Table 13.

TABLE 13

| | | | | | Growth promoting | |
|---|---|---|---|---|---|---|
| | | Zn | | | Factor | |
| | | Concentration | ZnO | | (Aerial Part | |
| Small | | of Nutrient | Content | Zn Content | Weight Ratio) | |
| Circulation | | Solution 7 | Weight | Percentage | Ratio to | Ratio to |
| Test No. | Mat 1 | (ppm) | (mg/piece) | (w/w %) | Test No. 1 | Test No. 2 |
| 1 | Comparative | 0.09 | 0.00 | 0.0 | 1.00 | 0.95 |
| | Example 1 | | | | | |
| 2 | Comparative | 1.00 | 0.00 | 0.0 | 1.06 | 1.00 |
| | Example 1 | | | | | |
| 3 | Example 1 | 0.09 | 9.49 | 2.0 | 1.27 | 1.20 |
| 4 | Example 1 | 1.00 | 9.49 | 2.0 | 1.18 | 1.12 |

As shown in FIG. 13, the plant growth promoting factor of the mat 1 of Example 1 was higher than that of the mat 1 of Comparative Example 1 independently of the Zn concentration of the nutrient solution 7. Comparison in Zn concentration of the nutrient solution 7 of the mat 1 of Comparative Example 1 between 0.09 ppm (small circulation test No. 1) and 1.00 ppm (small circulation test No. 2) shows that an increase in Zn concentration increases the growth promoting effect a little. When the ZnO particles 2 are contained in the mat 1, like the mat 1 of Example 1, the growth promoting effect increased by 20% or more.

This result confirmed that the plant growth promoting effect is produced more easily when the ZnO particles 2 are contained in the mat 1. This is proven by the results of above-described examinations which revealed that, when the ZnO particles 2 were added to the mat 1, the root acids secreted from the roots elutes Zn ions and the Zn ions are retained in the mat 1 without flowing into the surrounding nutrient solution 7 due to water retention of the mat 1.

In general hydroponic culture, the roots of the plants 6 are immersed in the circulating nutrient solution 7, and the root acids secreted from the roots do not remain in the rhizosphere thereof. The roots hardly absorb the citric acid-soluble compounds. By adding water-soluble compounds to the nutrient solution 7, the effect of absorbing the same compounds. However, essential micronutrients contained in the nutrient solution at a low concentration cannot be absorbed efficiently. Furthermore, controlling the essential micronutrients is very difficult in hydroponic cultivation and is inefficient.

In the present invention, the ZnO particles 2 are contained in the mat 1. This maximizes the effect of the feature of the ZnO particles 2 which are citric acid-soluble.

### [E] Consider the Principle of Plant Growth Promoting Effect Due to Particles Made of Zn Compound

### [E-1] Promotion of Photosynthesis (Examination 1)

### (Photosynthesis Test)

Zn is at the active center of carbonic anhydrase (CA) necessary for supplying CO₂ to the Calvin-Benson cycle, which is a basic cycle of photosynthesis of plants. It is inferred that adding Zn to the mat 1 increases CA and thereby increases the rate of photosynthesis, promoting the growth of plants. Hereinafter, it was examined if the mat 1 of the present invention actually increased the rate of photosynthesis.

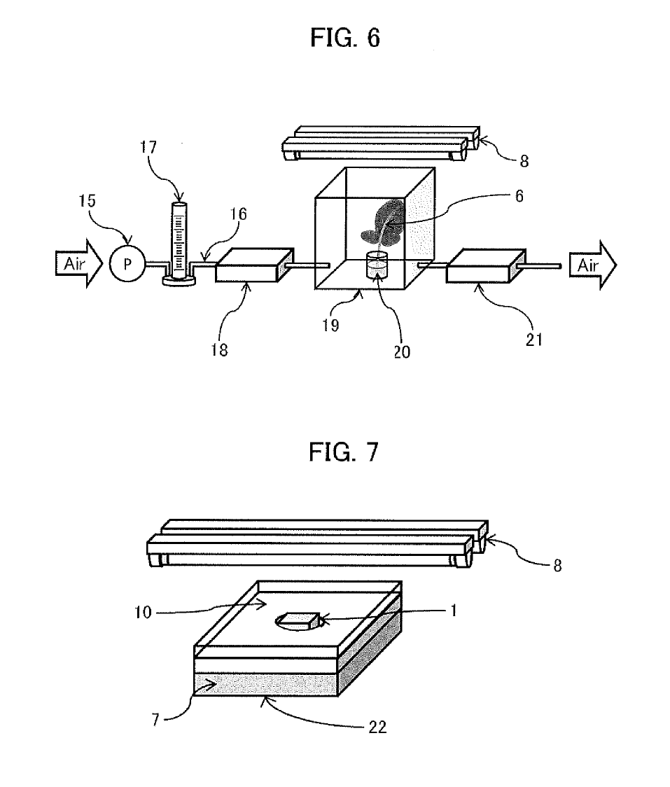

The photosynthesis test was performed using the apparatus illustrated in FIG. 6.

### [Test Method]

(1) The plant 6 was placed in the chamber 19. The “chamber” in the present invention is a sealable vessel for photosynthesis of plants. The chamber 19 is made of transparent acrylic resin. The chamber 19 is provided with an inlet of air into the chamber 19 and an outlet of air from the chamber 19. The plant 6 is placed in the chamber 19, and the chamber 19 is sealed. The plant 6 is irradiated with light from the light source 8 to perform photosynthesis. The rate of photosynthesis calculated based on the CO₂ concentrations of air upstream and downstream of the chamber 19.
(2) The plant 6 was put in a beaker with water 20 for water uptake.
(3) CO₂ concentration-adjusted gas was supplied to the chamber 19 via the flowmeter 17 and supply air-side CO₂ monitor 18 by the air pump 15. The gas was supplied at a flow rate of 500 mL/min.
(4) The chamber 19 was irradiated by the light source 8 from above for photosynthesis. The light source 8 was a three-band fluorescent lump (daylight) with a luminance of 15,000 lx.
(5) The air after photosynthesis was exhausted via the exhaust air-side CO₂ monitor 21.
(6) The rate of photosynthesis per leaf area of the plant 6 was calculated from the relationship between the difference in CO₂ concentration between the supply air and exhausted air and the flow rate of air. The test time was 30 minutes.

As illustrated in Table 14, the small circulation test was performed using the mats 1 of Example 1 and Comparative Example 1. Furthermore, comparative examination was performed with the nutrient solution 7 which was obtained by adding the ZnO particles 2 to the nutrient solution 7 so that the nutrient solution 7 has the same Zn concentration as that when the mat 1 containing the ZnO particles 2 at 2 w/w % leaks Zn to the nutrient solution 7 (1.86 ppm at seedling with 20 mL/plant, 0.0372 ppm at settled planting with 1 L/plant). The test was performed under the following conditions. The cultivated plants were leaf radish. The number of cultivation days was set as follows: the period of 1. Germination was three days; the period of 2. Seedling was seven days; and the period of 3. Settled planting was nine days.

The ratio of the weight of aerial part of the picked plants hydroponically cultivated in each mat 1 to the weight of aerial part of the plant hydroponically cultivated in the mat 1 of Comparative Example 1 (not containing an essential element) was calculated as a growth promoting factor. At the end of the hydroponic cultivation, the rate of photosynthesis was calculated in the photosynthesis test. The ratio of the rate of photosynthesis in each cultivation to the rate of photosynthesis in cultivation using the mat 1 of Comparative Example 1 was calculated as a photosynthesis promoting factor. The CO₂ concentration of inlet air supplied was set to 700 ppm. The results are shown in Table 14.

TABLE 14

| | Comparative | | Comparative |
|---|---|---|---|
| | Example 1 | Example 1 | Example 1 |
| | (Not Containing | (Containing | (Not Containing |
| Mat 1 | ZnO) | ZnO) | ZnO) |
| Addition O of | Added | Not Added | Not Added |
| ZnO Particles 2 to | | | |
| Nutrient Solution 7 | | | |
| Harvest Weight (g) | 21.4 | 25.5 | 19.1 |
| (19 Days) | | | |
| Growth Promoting | 1.12 | 1.34 | — |
| Factor | | | |
| (Aerial Part Weight | | | |
| Ratio) | | | |
| Rate of | 4.33 | 5.49 | 3.18 |
| photosynthesis | | | |
| (μmol · s⁻¹ · m⁻²) | | | |
| Photosynthesis | 1.36 | 1.72 | — |
| Promoting Factor | | | |

As shown in Table 14, it was confirmed that supply of Zn to plants increased the rate of photosynthesis. Furthermore, it was confirmed that the rate of photosynthesis per leaf area was higher when 9.49 mg of the ZnO particles 2 are contained in the mat 1, like the mat 1 of Example 1.

### [E-2] Promotion of Photosynthesis (Examination 2)

The aforementioned [E-1] confirmed that supply of Zn to plants increased the rate of photosynthesis. In plant factories, cultivation is carried out with the CO₂ concentration increased to 700 to 2000 ppm for promoting photosynthesis. It was then examined if the mat 1 increased the rate of photosynthesis in a similar manner even when the CO₂ concentration changed.

The examination was performed by hydroponic cultivation of plants in the aforementioned small circulation test using the mats 1 according to Example 1 and Comparative Example 1 as shown in Table 15. The cultivated plants were Frillice. The number of cultivation days was set as follows: the period of 1. Germination was three days; the period of 2. Seedling was ten days; and the period of 3. Settled planting was 43 days.

After the hydroponic cultivation was finished, the rate of photosynthesis was calculated in the aforementioned photosynthesis test. The CO₂ concentration of inlet air supplied and the cultivation conditions were the same as those of the aforementioned [E-1]. The results thereof are shown in Table 15 and FIG. 10.

| | | | | Growth Promoting |
|---|---|---|---|---|
| | | Comparative | | Factor (Aerial |
| | | Example 1 | | Part Weight |
| | | (Not | Example 1 | Ratio) & |
| | | Containing | (Containing | Synthesis |
| Mat 1 | | ZnO) | ZnO) | Promoting Factor |
| Addition of Zn | | Added | Not Added | — |
| Particles 2 to Nutrient | | | | |
| Solution 7 | | | | |
| Harvest Weight [g] | | 66.9 | 75.6 | 1.13 |
| (57 Days) | | | | |
| Rate of photosynthesis | | | | |
| (μmol · s⁻¹ · m⁻²) | | | | |
| CO₂ | 700 | 2.56 | 3.34 | 1.31 |
| Concentration | 1000 | 4.53 | 6.16 | 1.36 |
| (ppm) | 1500 | 6.78 | 9.39 | 1.38 |
| | 2000 | 8.38 | 11.63 | 1.39 |

As shown in Table 15 and FIG. 10, it was confirmed that the rate of photosynthesis was higher throughout from the low to high CO₂ concentration in hydroponic cultivation using the mat 1 of Example 1, which contains 9.49 mg of the ZnO particles 2 than that in the case using the mat 1 of Comparative Example 1. Consequently, Zn ions are absorbed through the roots, and some of the Zn ions turn into CA. This increases the amount of photosynthesis, providing the plant growth promoting effect.

### [F] Confirm and Consider Anti-Algae Effect

### [F-1] Relationship Between Particle Size and Algae Prevention Ratio

### (Algae Test)

Next, it was confirmed that the ZnO particles 2 contained in the mat 1 caused Mie scattering or Rayleigh scattering depending on the particle size thereof and thereby reduced transmission of light from the top surface of the mat 1 into the mat 1 to prevent generation and propagation of algae. To confirm the difference between the effect due to light scattering and the antibacterial effect of ZnO as an effect on preventing algae, examination was performed using the nutrient solution 7 containing ZnO, separately from the mats 1 containing the ZnO particle 2.

The algae test was performed using the apparatus illustrated in FIG. 7 as follows.

### (Test Method)

(1) The small test vessel 22 was filled with the nutrient solution 7. The mat 1 impregnated with the nutrient solution 7 was fixed in the hole provided at the center of the planting board 10. The top surface of the planting board 10 was positioned at the same height as the top surface of the mat 1. The mat 1 was floated in the nutrient solution 7. The nutrient solution 7 was 150 mL, and the mat 1 was 24 mm long, 24 mm wide, and 28 mm thick.
(2) Water including algae was poured into the nutrient solution 7, and the mixture was placed under the light source 8.
(3) The number of algae included in the nutrient solution 7 was adjusted to 232 algae/μL at the start.
(4) The light source 8 was a three-band fluorescent lamp (daylight). The planting board 10 was irradiated with the light source 8 under the following conditions: the illuminance was 18,000 lx; and irradiation time was 24 hours/day. The apparatus was left to stand for one week.
(5) After the apparatus was left for one week, the nutrient solution 7 included in the mat 1 with algae propagated was collected as a sample, and the propagation of algae in the mat 1 was confirmed.
(6) The sample was taken into vials and was diluted by an arbitrary factor. The number of algae was counted using an observation device and a hemocytometer.

The test vessel, planting board, and measurement equipment were as follows.

### (Test Vessel and Planting Board)

Test vessel: 80 mm×80 mm×50 mm

Planting board: 70 mm×70 mm×10 mm

### (Measurement Equipment)

Equipment: hemocytometer (Neubauer Improved type) by Hirschmann Laborgerate

Observation device: digital microscope KH-7700 by HIROX Co., Ltd.

The examination used the mats 1 of Examples and Comparative examples which contained 4.84 mg/piece of the ZnO particles 2 with various average particle sizes. The mats 1 were prepared with the ZnO particles 2 made of ZnO with average particle sizes of 0.01 to 10 μm shown in Table 1. ZnO with average particle sizes of 0.01 μm and 10 μm was made by HakusuiTech Co., Ltd., and ZnO with the other average particle sizes were made by SAKAI CHEMICAL INDUSTRY Co., Ltd. For comparison with these mats 1, the mat 1 of Comparative Example 1 was prepared in the same manner as described above.

The relationship between the average particle size and the algae prevention ratio was confirmed through the aforementioned algae test.

To confirm if the antibacterial effect of ZnO produces the anti-algae effect, examination was performed for the mat of Comparative Example 1 with the ZnO particles 2 having an average particle size of 0.02 to 0.60 μm added to the nutrient solution 7 (the content was 40 mg/L and 4.2 mg/L) as shown in Table 16. The results are shown in Table 16. The symbols “-” indicate that the evaluation was not performed. The “algae prevention ratio” in the present invention refers to a ratio of a decrease in number of algae to a reference number of algae which was obtained at the algae test performed with no ZnO added to both the mat 1 and the nutrient solution 7 and no toner added to the mat 1.

TABLE 16

| | | Algae Prevention Ratio [%] | | | | |
|---|---|---|---|---|---|---|
| | | | | | | No ZnO |
| | | | | | | was |
| | | | | ZnO | ZnO | contained |
| | | | | Content | Content of | in Mat 1 |
| | | ZnO Content | | of nutrient | Nutrient | and |
| | | of Mat 1 | | solution 7 | Solution 7 | Nutrient |
| | | 4.84 mg/piece | | 40 mg/L | 4.2 mg/L | Solution 7 |
| ZnO | 0.01 | Comparative | 12.2 | — | — | 0.00 |
| Average | | Example 23 | | | | |
| Particle | 0.02 | Example 7 | 34.4 | 7.54 | −35.5 | |
| Size | 0.29 | Example 2 | 45.1 | 9.96 | −18.3 | |
| (μm) | 0.45 | Example 8 | 30.9 | — | — | |
| | 0.60 | Example 9 | 22.2 | 5.26 | −14.5 | |
| | 1 | Comparative | 21.1 | — | — | |
| | | Example 24 | | | | |
| | 2 | Comparative | 19.7 | — | — | |
| | | Example 25 | | | | |
| | 10 | Comparative | 21.6 | — | — | |
| | | Example 26 | | | | |

As for the wavelength of light used for photosynthesis by chlorophyll, for example, the wavelength of light used by chlorophyll a and chlorophyll b contained in algae ranges from about 400 to 500 nm and from about 550 to 700 nm. The particle size that is maximizes Mie scattering is calculated based on these ranges of wavelength to 0.2 to 0.7 μm. In addition, the light source 8 currently employed is a three-band fluorescent lamp (daylight). The wavelength of light which is emitted from the three-band fluorescent lamp (daylight) and is absorbed by the chlorophyll a and b is 440 to 480 nm and around 610 nm. The preferable average particle size is therefore 0.3 μm. As shown in Table 16, it was confirmed that the anti-algae effect (algae prevention ratio) was maximized when the ZnO particles 2 contained in the mat 1 had an average particle size of 0.29 μm (Example 2). Furthermore, when the ZnO particles 2 contained in the mat 1 had an average particle size of 0.02 μm (Example 7), the effect of preventing algae was obtained due to Rayleigh scattering. When the ZnO particles 2 contained in the mat 1 had an average particle size of 0.01 μm (Comparative Example 23), however, the algae prevention ratio was reduced. This is considered to be because reduction in particle size increases visible light transmittance due to the characteristics of Rayleigh scattering.

The algae prevention ratio is thus maximized by selecting an average particles size (0.02 to 0.7 μm) in accordance with the wavelength of light emitted from the light source also when the light source is an LED and sunlight.

On the other hand, the effect of preventing algae in the mat 1 was hardly provided when only the nutrient solution 7 contained the ZnO particles 2. When the content of the ZnO particles 2 of the nutrient solution 7 was 4.2 mg/L, generation and propagation of algae was promoted in the mat 1. As described above, generation of algae needs “light”, “water”, and “nutrients”, and the ZnO including Zn, which is an essential micronutrient, promoted generation and propagation of algae similarly to plants. Consequently, the algae prevention ratio is maximized by utilizing Mie scattering or Rayleigh scattering due to the ZnO particles 2 contained in the mat 1 to reduce light transmission into the mat 1 from the top surface of the mat 1 rather than by utilizing the antibacterial effect of the ZnO particles to prevent algae.

### [F-2] Antibacterial Effect of ZnO

### (Antibacterial Test)

In the aforementioned [F-1], the anti-algae effect was not confirmed even when the ZnO particles 2 were added to the nutrient solution 7. In this test, to further confirm the antibacterial effect of ZnO, the total plate count was determined.

### [Total Plate Count Determination Method]

The total plate count was calculated by the following method.

### (Dilution)

(1) The dilution was carried out in a clean booth to prevent mixture of bacteria from the outside of the system.
(2) Using a pipette chip, 1 mL nutrition solution was dispensed in a glass vial as a specimen.
(3) 9 mL dilution water (sterile phosphate buffered saline) was poured into the nutrition solution in the glass viable and was stirred to produce a 10-fold dilution specimen.
(4) The same dilution operation was repeated to prepare a specimen diluted so that the number of colonies was 30 to 300 after bacterial culture.

### (Inoculation)

(5) Inoculation was carried out in a clean booth to prevent mixture of bacteria from the outside of the system.
(6) A Petrifilm AC plate (by 3M Japan Limited) was placed on a flat surface, and the top film was lifted.
(7) 1 mL of the specimen properly diluted was dropped at the center of the lower film of the Petrifilm.
(8) The lifted top film was released and naturally dropped.
(9) A spreader (a pressing plate) was placed on the top film corresponding to the drop with the curved surface down.
(10) The spreader was pressed from above so as to spread the drop in a circular manner.
(11) The spreader was removed, and the drop was left for one minute or more for gelation.

### (Culture)

(12) Culture was performed with the top film up. The culture conditions were: 35±1° C.; and 48±3 hours.

### (Enumeration)

(13) The Petrifilm with the culture finished was extracted from the constant temperature bath, and the number of colonies stained red was enumerated.

### (Calculation)

(14) The measured number of colonies was multiplied by the dilution factor into a total plate count of the specimen before dilution.

The examination used the mats 1 of Examples 7 and 9 (containing 4.84 mg/piece of the ZnO particles 2 with different average particle sizes), as Examples and Comparative Examples, as shown in Table 17. For comparison with these mats 1, the mat 1 of Comparative Example 1 was manufactured in the same way as described above.

The small circulation test was performed using those mats 1. The cultivated plants were Frillice. The number of cultivation days was set as follows: the period of 1. Germination was three days; 2. Seedling was not performed; and the period of 3. Settled planting was 11 days. The total plate counts of the nutrient solution 7 in the mats 1 and the nutrient solution 7 in the tank were obtained by the total plate count determination method. The results thereof were shown in Table 17.

TABLE 17

| | ZnO | Total Plate Count (CFU/ml) | |
|---|---|---|---|
| | Average particle | Nutrient Solution | Nutrient Solution |
| Mat 1 | Size (μm) | 7 in Tank | in Mat 1 |
| Example 9 | 0.6 | 3.5 × 10⁴ | 1.0 × 10⁵ |
| Example 7 | 0.02 | 2.1 × 10⁴ | 2.3 × 10⁵ |
| Comparative | Not contained | 2.5 × 10⁴ | 1.7 × 10⁵ |
| Example 1 | | | |

The results shown in Table 17 include no large difference in total plate count in any example. In other words, it was confirmed that the antibacterial effect was not obtained in any example. These results confirmed that the anti-algae effect was not produced by the antibacterial effect but by an operation different from the antibacterial effect, similarly to the results obtained in [F-1].

### [F-3] Anti-Algae Effect of ZnO in Relation to Number of Cells

### [Algae Test]

The anti-algae effect of the ZnO particles 2 was confirmed with the number of cells of the mat 1 varied. As illustrated in FIG. 18, the confirmation was performed through the algae test using the mats 1 of Examples 1, 5, and 6 and Comparative Examples 1, 21, and 22. The number of cells of each mat 1 and the test results (the algae prevention ratio) are shown in Table 18.

TABLE 18

| | | | | Algae |
|---|---|---|---|---|
| | Number of | ZnO Content | ZnO Content | Prevention |
| | Cells | Weight | Percentage | Ratio |
| Mat 1 | (pores/25 mm) | (mg/piece) | (w/w %) | [%] |
| Comparative | 50 | 0.00 | 0.0 | 0.00 |
| Example 1 | | | | |
| Comparative | 13 | 0.00 | 0.0 | 20.05 |
| Example 21 | | | | |
| Example 1 | 50 | 9.49 | 2.0 | 39.02 |
| Example 5 | 30 | 9.49 | 2.0 | 41.08 |
| Example 6 | 13 | 9.49 | 2.0 | 20.58 |
| Comparative | 7.5 | 9.49 | 2.0 | 27.00 |
| Example 22 | | | | |

The results in Table 18 confirmed that compared with the mat 1 (Comparative Example 1) including 50 pores/25 mm and not containing the ZnO particles 2, the number of algae was reduced a little in the mat 1 (Comparative Example 21) including 13 pores/25 mm and not containing ZnO particles 2. Because of the lower water retention capacity, upper part of the mat 1 was dried, and the propagation of algae is inhibited.

On the other hand, it was confirmed that the mats 1 (Examples 1 and 5) including 50 pores/25 mm and 30 pores/25 mm and containing 9.49 mg/piece of the ZnO particles 2 produced an excellent anti-algae effect. The mats 1 (Example 6 and Comparative Example 22) similarly containing 9.49 mg/piece of the ZnO particles 2 but including 13 pores/25 mm and 7.5 pores/25 mm resulted in an algae prevention ratio equal to that of the mat 1 (Comparative Example 21) not containing the ZnO particles 2 and including 13 pores/25 mm. When the number of cells of the mats 1 was small, that is, the cells were coarse, the ZnO particles 2 distributed and fixed in the struts were less likely to be irradiated with light, not providing a light scattering effect. Those mats 1 therefore had only the anti-algae effect due to the dried upper part of the mat 1.

Based on the results of [D-2] and [F-3], the number of cells of the mat 1 is preferably 10 to 100 pores/25 mm and more preferably 30 to 70 pores/25 mm. The mat 1 with such a number of cells produces effects on promoting the plant growth and preventing algae.

### [F-4] Anti-Algae Effect of Coloring of Mat

### (Algae Test)

The mat 1 was colored, and the anti-algae effect due to the lightness of the mat 1 was examined.

The mats 1 were produced by replacing the ZnO particles 2 with toner FTR-5570 (20-30% carbon black, by Dainichiseika Color & Chemicals Mfg. Co., Ltd.). As Comparative Examples 27, 28, 29, 30, and 31, the lightness of the mats 1 was adjusted by changing the content of toner.

The examination was performed through the algae test using the mats 1 of the aforementioned comparative examples and the mat 1 of Comparative Example 1 not containing the toner FTR-5570. The results thereof are shown in Table 19. The lightness was measured using a simplified spectrophotometer NF333 (by NIPPON DENSHOKU INDUSTRIES Co., LTD.).

TABLE 19

| | Comparative | Comparative | Comparative | Comparative | Comparative | Comparative |
|---|---|---|---|---|---|---|
| Mat 1 | Example 1 | Example 27 | Example 28 | Example 29 | Example 30 | Example 31 |
| FRT-5570 | 0.00 | 0.13 | 0.50 | 1.00 | 1.25 | 2.91 |
| Content | | | | | | |
| (w/w %) | | | | | | |
| Lightness | 85 | 66 | 47 | 39 | 38 | 31 |
| (L*) | | | | | | |
| Algae | 0 | 54 | 69 | 90 | 91 | 94 |
| Prevention | | | | | | |
| Ratio (%) | | | | | | |

As shown in Table 19, the algae prevention ratio increased with a decrease in lightness of the color of the mats 1. This is because the color of the mats 1 absorbs light and reduces entering light.

However, it was confirmed that when the mat had a low lightness, dark color, the reflection of light was reduced, and the plants 6 grew in a spindly way. The spindly growth leads to quality degradation. The “spindly growth” in this specification refers to the phenomenon that plants' leaves and stems stretch out more than necessary due to lack of light. The plants having grown spindly are weak and subject to diseases, and the crop yield thereof is reduced.

### (Influence of Lightness on Amount of Light)

It was examined how much the lightness of the mat 1 influences the amount of light.

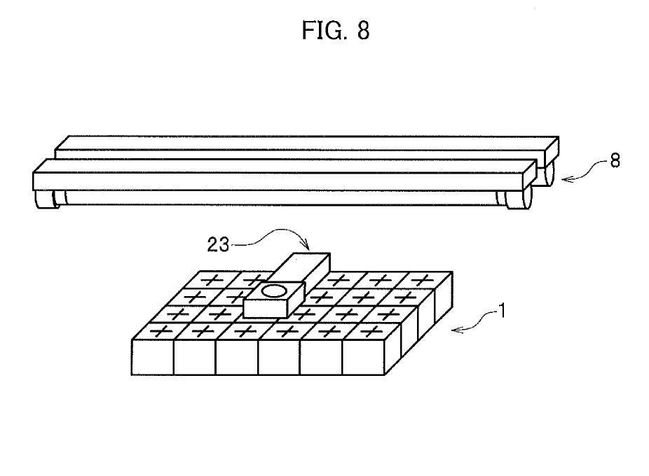

The light source 8 was a three-band fluorescent lamp (daylight). Under the light source 8, 24 (4×6) pieces (overall size: 96 mm×144 mm×28 mm) of colored mats 1 were placed at 15 cm from the light source 8 for measurement of the amount of light. The amount of light was measured with a digital lux meter (by Intell Instruments Plus). The test was performed as illustrated in FIG. 8. The illuminometer 23 was placed on the mat 1 with the sensor facing the light source 8 for measurement of the amount of light. The results thereof are shown in Table 20.

TABLE 20

| Mat 1 | Lightness | Amount of Light (lx) |
|---|---|---|
| Comparative Example 1 | 85 | 17,700 |
| Comparative Example 32 | 63 | 16,500 |
| Comparative Example 30 | 38 | 14,800 |

As shown in Table 20, it was confirmed that the amount of light decreased as the lightness decreased. This is because the lower the lightness, the more light the mat 1 absorbs, reducing the amount of light. In the initial stage of seedling, where the plants are still small, the phenomenon of spindly growth occurs by the difference in amount of light.

The prevention of growth of algae due to coloring of the mat 1 produces a higher anti-algae effect in combination with the anti-algae effect of the ZnO particles 2. However, coloring of the mat 1 could influence the growth of the plant 6. It is therefore necessary to adjust the lightness of the mat 1 and take care of the plants 6 in the initial stage of seedling, where the plants 6 are small.

### [F-5] Confirm Anti-Algae Effect and Plant Growth Promoting Effect

### (Small Circulation Test)

The examinations of the [F-1] to [F-4] confirmed the anti-algae effect of the ZnO particles 2. This test confirmed that prevention of algae effectively prevents growth inhibition of plants and confirmed the plant growth promoting effect of the ZnO particles 2. This examination used the mats of Example 1 and

Comparative Example 33. For comparison with these mats 1, the mat 1 not containing the ZnO particles 2 as Comparative Example 1 was manufactured in the same manner as described above.

The anti-algae effect and plant growth promoting effect due to the particles were confirmed through the small circulation test.

The cultivated plants were leaf radish. The number of cultivation days were set as follows: the period of 1. Germination was three days; the period of 2. Seedling was seven days; and the period of 3. Settled planting was 11 days. The algae prevention ratio to Comparative Example 1 was calculated. Furthermore, the ratio of the weight of aerial part of the plant hydroponically cultivated in each mat 1 to the weight of aerial part of the plant hydroponically cultivated in the mat 1 of Comparative Example 1 (not containing an essential element) was calculated as a growth promoting factor. The results are shown in Table 21.

TABLE 21

| | | | Growth promoting |
|---|---|---|---|
| | | | Factor |
| | Additive (Particle | Algae Prevention | (Aerial Part |
| Mat 1 | or Toner) | Ratio (%) | Weight Ratio) |
| Comparative | No additive | 0 | 1.00 |
| Example 1 | | | |
| Comparative | FTR-5570 | 29 | 1.32 |
| Example 33 | | | |
| Example 1 | ZnO | 32 | 1.51 |

As shown in Table 21, it was confirmed that when FTR-5570 (Comparative Example 33) and ZnO particles 2 (Example 1) produced equivalent anti-algae effects, the weights of both plants cultivated with FTR-5570 (Comparative Example 33) and ZnO particles 2 (Example 1) were increased compared with Comparative Example. 1. This is because prevention of algae reduces growth inhibition of plants due to algae as described above. Furthermore, it was confirmed that the weight of the plant of Example 1, which contained an essential micronutrient Zn, was especially increased.

As described above, the plant growth promoting effect of the mat 1 satisfying the requirements of present invention is able to solve the demands of producers of hydroponic culture in plant factories to shorten the period from sowing to harvesting or increase the weight of crop. Furthermore, the anti-algae effect involved in the mat 1 satisfying the requirements of the present invention prevents the mat supporting the roots of plants, such as vegetables in particular, from being contaminated with algae. The plants cultivated in the mat 1 look good and are preferred by consumers.

### REFERENCE SIGNS LIST

1 MAT (HYDROPONIC MAT)
2 ZnO PARTICLE
3 RESIN FOAM

1. A hydroponic mat, comprising
a resin foam including not less than 4.5 mg/piece and not greater than 15.0 mg/piece of zinc oxide having an average particle size of not less than 0.02 μm and not greater than 0.7 μm.

2. The hydroponic mat according to claim 1, wherein the resin foam is flexible polyurethane foam.
